(19) United States
(12) Patent Application Publication
(10) Pub. No.: US 2013/0057443 A1
(43) Pub. Date: Mar. 7, 2013

(54) ANTENNA DEVICE, AND WIRELESS COMMUNICATION DEVICE

(71) Applicants: Kenichi Asanuma, Kyoto (JP); Atsushi Yamamoto, Kyoto (JP); Tsutomu Sakata, Osaka (JP); Kenichi Kozaki, Miyazaki (JP)

(72) Inventors: Kenichi Asanuma, Kyoto (JP); Atsushi Yamamoto, Kyoto (JP); Tsutomu Sakata, Osaka (JP); Kenichi Kozaki, Miyazaki (JP)

(21) Appl. No.: 13/697,892

(22) PCT Filed: Jan. 31, 2012
(86) PCT No.: PCT/JP2012/000615

§ 371 Date: Nov. 14, 2012

(30) Foreign Application Priority Data
Mar. 16, 2011 (JP) 2011-057555

(51) Int. Cl. H01Q 9/16; H01Q 21/28

(52) U.S. Cl. 343/751; 343/749

(57) ABSTRACT

A radiators has looped radiation conductors, an inductor, a capacitor, a feed point on the radiation conductor. The capacitor is formed by a capacitance between the radiation conductors, and the capacitance varies depending on positions on the radiation conductors within a portion where the radiation conductors are close to each other. The radiators is configured to: resonate along a portion of the radiator at a low-band resonance frequency, the portion including the inductor and the capacitor and being along the loop of the radiation conductor, and resonate along a portion of the radiator at a high-band resonance frequency, the portion including a section along the loop of the radiation conductor, the section including at least one of the at least one capacitor, not including the inductor, and extending between the feed point and the inductor.

The present invention relates to an antenna apparatus mainly for use in mobile communication such as mobile phones, and relates to a wireless communication apparatus provided with the antenna apparatus.

### BACKGROUND ART

The size and thickness of portable wireless communication apparatuses, such as mobile phones, have been rapidly reduced. In addition, the portable wireless communication apparatuses have been transformed from apparatuses to be used only as conventional telephones, to data terminals for transmitting and receiving electronic mails and for browsing web pages of WWW (World Wide Web), etc. Further, since the amount of information to be handled has increased from that of conventional audio and text information to that of pictures and videos, a further improvement in communication quality is required. In such circumstances, there are proposed a multiband antenna apparatus and a compact antenna apparatus, supporting a plurality of wireless communication schemes. Further, there is proposed an array antenna apparatus capable of reducing electromagnetic coupling among antenna apparatuses each corresponding to the above mentioned one, and thus performing high-speed wireless communication.

According to an invention of Patent Literature 1, a two-frequency antenna is characterized by having: a feeder, an inner radiation element connected to the feeder and an outer radiation element, all of which are printed on a first surface of a dielectric board; an inductor formed in a gap between the inner radiation element and the outer radiation element printed on the first surface of the dielectric board to connect the two radiation elements; a feeder, an inner radiation element connected to the feeder and an outer radiation element, all of which are printed on a second surface of a dielectric board; and an inductor formed in a gap between the inner radiation element and the outer radiation element printed on the second surface of the dielectric board to connect the two radiation elements. The two-frequency antenna of Patent Literature 1 is operable in multiple bands by forming a parallel resonant circuit from the inductor provided between the radiation elements and a capacitance between the radiation elements.

According to an invention of Patent Literature 2, a multiband antenna includes an antenna element having a first radiation element and a second radiation element connected to respective opposite ends of an LC parallel resonance circuit, and is characterized in that the LC parallel resonant circuit is constituted of self-resonance of an inductor itself. The multiband antenna of Patent Literature 2 is operable in multiple bands due to the LC parallel resonant circuit constituted of the self-resonance of the inductor of a whip antenna itself.

### CITATION LIST

### Patent Literature

PATENT LITERATURE 1: Japanese Patent Laid-open Publication No. 2001-185938
PATENT LITERATURE 2: Japanese Patent Laid-open Publication No. H11-055022
PATENT LITERATURE 3: Japanese Patent No. 4003077
PATENT LITERATURE 4: Japanese Patent No. 4141645
PATENT LITERATURE 5: Japanese Patent Laid-open Publication No. 2005-026742
PATENT LITERATURE 6: Japanese Patent Laid-open Publication No. 2005-229365

### SUMMARY OF INVENTION

### Technical Problem

In recent years, there has been an increasing need to increase the data transmission rate on mobile phones, and thus, a next generation mobile phone standard, 3G-LTE (3rd Generation Partnership Project Long Term Evolution) has been studied. According to 3G-LTE, as a new technology for an increased the wireless transmission rate, it is determined to use a MIMO (Multiple Input Multiple Output) antenna apparatus using a plurality of antennas to simultaneously transmit or receive radio signals of a plurality of channels by spatial division multiplexing. The MIMO antenna apparatus uses a plurality of antennas at each of a transmitter and a receiver, and spatially multiplexes data streams, thus increasing a transmission rate. Since the MIMO antenna apparatus uses the plurality of antennas so as to simultaneously operate at the same frequency, electromagnetic coupling between the antennas becomes very strong under circumstances where the antennas are disposed close to each other within a small-sized mobile phone. When the electromagnetic coupling between the antennas becomes strong, the radiation efficiency of the antennas degrades. Therefore, received radio waves are weakened, resulting in a reduced transmission rate. Hence, it is necessary to provide an low coupling array antenna in which a plurality of antennas are disposed close to each other. In addition, in order to implement spatial division multiplexing, it is necessary for the MIMO antenna apparatus to simultaneously transmit or receive a plurality of radio signals having a low correlation therebetween, by using different radiation patterns, polarization characteristics, or the like. Furthermore, a technique for increasing the bandwidth of antennas is required in order to increase communication rate.

According to the two-frequency antenna of Patent Literature 1, if decreasing the low-band operating frequency, the size of the radiation elements should be increased. In addition, no contribution to radiation is made by slits between the inner radiation elements and the outer radiation elements.

According to the multiband antenna of Patent Literature 2, if the antenna is to operate in a low band, the element lengths of the radiation elements should be increased. In addition, no contribution to radiation is made by the LC parallel resonant circuit.

Therefore, it is desired to provide an antenna apparatus capable of achieving both multiband operation and size reduction.

An object of the present invention is to solve the above-described problems, and to provide an antenna apparatus capable of achieving both multiband operation and size reduction, and to provide a wireless communication apparatus provided with such an antenna apparatus.

### Solution to Problem

According to an antenna apparatus of the first aspect of the present invention, an antenna apparatus including at least one radiator. Each of the radiators has: a looped radiation conductor; at least one capacitor inserted at a position along a loop of the radiation conductor; at least one inductor inserted at a position along the loop of the radiation conductor, the position being different from the position of the capacitor; and a feed point provided on the radiation conductor. The radiation conductor includes at least a first radiation conductor and a second radiation conductor. A first capacitor of the at least one capacitor is formed by a capacitance between the first and second radiation conductors, and the capacitance between the first and second radiation conductors varies depending on positions on the first and second radiation conductors within a portion where the first and second radiation conductors are close to each other. Each of the radiators is configured to: resonate along a portion of the radiator at a first frequency, the portion including the inductor and the capacitor and being along the loop of the radiation conductor; and resonate along a portion of the radiator at a second frequency higher than the first frequency, the portion including a section along the loop of the radiation conductor, the section including at least one of the at least one capacitor, not including the inductor, and extending between the feed point and the inductor.

In the antenna apparatus, the first capacitor of each of the radiators is configured such that within a portion where the first and second radiation conductors are close to each other and overlap each other, at least one of the first and second radiation conductors has a tapered shape, and areas of sub-portions of the portion vary depending on positions on the first and second radiation conductors.

In the antenna apparatus, the first capacitor of each of the radiators is configured such that a distance between the first and second radiation conductors varies depending on positions on the first and second radiation conductors.

In the antenna apparatus, the first capacitor of each of the radiators is configured such that a dielectric is provided between the first and second radiation conductors, and a dielectric constant of the dielectric varies depending on positions on the first and second radiation conductors.

In the antenna apparatus, the first capacitor of each of the radiators is configured such that at least one of the first and second radiation conductors has a tapered shape.

The antenna apparatus is further provided with a matching circuit.

In the antenna apparatus, each of the radiators further has a second capacitor inserted at a closer position to the feed point along the loop of the radiation conductor, than the position of the first capacitor, and a capacitance of the second capacitor is larger than the capacitance of the first capacitor.

In the antenna apparatus, each of the radiators further has an extension conductor connected to an outer edge of the loop of the radiation conductor, between the first and second capacitors. Each of the radiators is configured to: resonate along a portion of the radiator at the first frequency, the portion including the inductor and the first and second capacitors and being along the loop of the radiation conductor; resonate along a portion of the radiator at the second frequency, the portion including a section along the loop of the radiation conductor, the section including the second capacitor, not including the inductor, and extending between the feed point and the first capacitor; and resonate along a portion of the radiator at a third frequency between the first and second frequencies, the portion including a section along the loop of the radiation conductor and including the extension conductor, the section including the second capacitor, not including the inductor, and extending between the feed point and the first capacitor.

In the antenna apparatus, each of the radiators further has a slit provided at an inner edge of the loop of the radiation conductor, between the first and second capacitors. Each of the radiators is configured to: resonate along a portion of the radiator at the first frequency, the portion including the inductor and the first and second capacitors, including the slit, and being along the loop of the radiation conductor; resonate along a portion of the radiator at the second frequency, the portion including a section along the loop of the radiation conductor, the section including the second capacitor, not including the inductor, and extending between the feed point and the first capacitor; and resonate along a portion of the radiator at a third frequency between the first and second frequencies, the portion including a section along the loop of the radiation conductor and including the slit, the section including the second capacitor, not including the inductor, and extending between the feed point and the first capacitor.

In the antenna apparatus, the radiation conductor is bent at at least one position.

In the antenna apparatus, the at least one inductor includes a chip antenna element. The chip antenna element is provided with: a bar dielectric member; a radiation element helically formed on a surface along a longitudinal direction of the dielectric member; and first and second electrodes connected to the radiation element at both ends of the dielectric member, respectively.

In the antenna apparatus, the at least one inductor includes an inductor made of a strip conductor.

In the antenna apparatus, the at least one inductor includes an inductor made of a meander conductor.

The antenna apparatus is further provided with a ground conductor.

The antenna apparatus is further provided with: a printed circuit board provided with the ground conductor, and a feed line connected to the feed point. The radiator is formed on the printed circuit board.

In the antenna apparatus, the antenna apparatus is a dipole antenna including at least a pair of radiators.

The antenna apparatus includes a plurality of radiators, the plurality of radiators having different first frequencies and different second frequencies, respectively.

The antenna apparatus includes a plurality of radiators connected to different signal sources.

The antenna apparatus includes a first radiator and a second radiator that have radiation conductors formed symmetrically with respect to a reference axis. Feed points of the first and second radiators are provided at positions symmetric with respect to the reference axis. The radiation conductors of the first and second radiators are shaped such that a distance between the first and second radiators gradually increases as a distance from the feed points of the first and second radiators along the reference axis increases.

The antenna apparatus includes a first radiator and a second radiator. Loops of radiation conductors of the first and second radiators are configured to be substantially symmetric with respect to a reference axis. When proceeding along the symmetric loops of the radiation conductors of the first and second radiators in corresponding directions starting from respective feed points, the first radiator is configured such that the feed point, the inductor, and the capacitor are located in this order, and the second radiator is configured such that the feed point, the capacitor, and the inductor are located in this order.

According to a wireless communication apparatus of the second aspect of the present invention, a wireless communication apparatus is provided with an antenna apparatus of the first aspect of the present invention.

### Advantageous Effects of Invention

According to the antenna apparatus of the present invention, it is possible to provide an antenna apparatus operable in multiple bands, while having a simple and small configuration. In addition, when the antenna apparatus of the present invention includes a plurality of radiators, the antenna apparatus has low coupling between antenna elements, and thus, is operable to simultaneously transmit or receive a plurality of radio signals. In addition, according to the present invention, it is possible to provide a wireless communication apparatus provided with such an antenna apparatus.

### BRIEF DESCRIPTION OF DRAWINGS

FIG. 1 is a schematic diagram showing an antenna apparatus according to a first embodiment of the present invention.

FIG. 2 is a diagram showing a current path for the case where the antenna apparatus of FIG. 1 operates at a low-band resonance frequency f1.

FIG. 3 is a diagram showing a current path for the case where the antenna apparatus of FIG. 1 operates at a high-band resonance frequency f2.

FIG. 4 is a diagram showing an equivalent circuit of the antenna apparatus of FIG. 1.

FIG. 5 is a schematic diagram showing an antenna apparatus according to a first comparison example for explaining the operating principle of the present invention.

FIG. 6 is a diagram showing a current path for the case where the antenna apparatus of FIG. 5 operates at the low-band resonance frequency f1.

FIG. 7 is a diagram showing a current path for the case where the antenna apparatus of FIG. 5 operates at the high-band resonance frequency f2.

FIG. 8 is a diagram for explaining a matching effect brought about by an inductor L1 and a capacitor C1 for the case where the antenna apparatus of FIG. 5 operates at the low-band resonance frequency f1.

FIG. 9 is a diagram for explaining a matching effect brought about by the inductor L1 and the capacitor C1 for the case where the antenna apparatus of FIG. 5 operates at the high-band resonance frequency f2.

FIG. 10 is a schematic diagram showing an antenna apparatus according to a first modified embodiment of the first embodiment of the present invention.

FIG. 11 is a schematic diagram showing an antenna apparatus according to a second modified embodiment of the first embodiment of the present invention.

FIG. 12 is a schematic diagram showing an antenna apparatus according to a third modified embodiment of the first embodiment of the present invention.

FIG. 13 is a schematic diagram showing an antenna apparatus according to a fourth modified embodiment of the first embodiment of the present invention.

FIG. 14 is a schematic diagram showing an antenna apparatus according to a fifth modified embodiment of the first embodiment of the present invention.

FIG. 15 is a schematic diagram showing an antenna apparatus according to a sixth modified embodiment of the first embodiment of the present invention.

FIG. 16 is a schematic diagram showing an antenna apparatus according to a seventh modified embodiment of the first embodiment of the present invention.

FIG. 17 is a schematic diagram showing an antenna apparatus according to a second comparison example of the present invention for explaining an effect brought about by providing a plurality of capacitors, and showing a current path for the case where the antenna apparatus operates at the low-band resonance frequency f1.

FIG. 18 is a diagram showing a current path for the case where the antenna apparatus of FIG. 17 operates at the high-band resonance frequency f2.

FIG. 19 is a schematic diagram showing an antenna apparatus according to an eighth modified embodiment of the first embodiment of the present invention.

FIG. 20 is a schematic diagram showing an antenna apparatus according to a ninth modified embodiment of the first embodiment of the present invention.

FIG. 21 is a schematic diagram showing an antenna apparatus according to a tenth modified embodiment of the first embodiment of the present invention.

FIG. 22 is a schematic diagram showing an antenna apparatus according to a second embodiment of the present invention.

FIG. 23 is a diagram showing a current path for the case where the antenna apparatus of FIG. 22 operates at the low-band resonance frequency f1.

FIG. 24 is a diagram showing a current path for the case where the antenna apparatus of FIG. 22 operates at a mid-band resonance frequency f3.

FIG. 25 is a diagram showing a current path for the case where the antenna apparatus of FIG. 22 operates at the high-band resonance frequency f2.

FIG. 26 is a schematic diagram showing an antenna apparatus according to a modified embodiment of the second embodiment of the present invention.

FIG. 27 is a diagram showing a current path for the case where the antenna apparatus of FIG. 26 operates at the low-band resonance frequency f1.

FIG. 28 is a diagram showing a current path for the case where the antenna apparatus of FIG. 26 operates at the mid-band resonance frequency f3.

FIG. 29 is a diagram showing a current path for the case where the antenna apparatus of FIG. 26 operates at the high-band resonance frequency f2.

FIG. 30 is a schematic diagram showing an antenna apparatus according to a third embodiment of the present invention.

FIG. 31 is a schematic diagram showing an antenna apparatus according to a first modified embodiment of the third embodiment of the present invention.

FIG. 32 is a schematic diagram showing an antenna apparatus according to a comparison example.

FIG. 33 is a schematic diagram showing an antenna apparatus according to a second modified embodiment of the third embodiment of the present invention.

FIG. 34 is a diagram showing current paths for the case where the antenna apparatus of FIG. 30 operates at the low-band resonance frequency f1.

FIG. 35 is a diagram showing a current path for the case where the antenna apparatus of FIG. 30 operates at the high-band resonance frequency f2.

FIG. 36 is a diagram showing a current path for the case where the antenna apparatus of FIG. 33 operates at the low-band resonance frequency f1.

FIG. 37 is a diagram showing a current path for the case where the antenna apparatus of FIG. 33 operates at the high-band resonance frequency f2.

FIG. 38 is a perspective view showing an antenna apparatus according to a fourth embodiment of the present invention.

FIG. 39 is an unfolded view of a radiation conductor 1d of a radiator 110A of FIG. 38.

FIG. 40 is an unfolded view of a radiation conductor 2 of the radiator 110A of FIG. 38.

FIG. 41 is a graph showing frequency characteristics of S parameters S11 and S21 representing the reflection coefficient and transmission coefficient of the antenna apparatus of FIG. 38.

FIG. 42 is a table showing frequency characteristics of the S parameter S11 representing the reflection coefficient of the antenna apparatus of FIG. 38.

FIG. 43 is a table showing a radiation efficiency of the antenna apparatus of FIG. 38.

FIG. 44 is a perspective view showing an antenna apparatus according to a modified embodiment of the fourth embodiment of the present invention.

FIG. 45 is an unfolded view of a radiation conductor 1e of a radiator 111A of FIG. 44.

FIG. 46 is an unfolded view of a radiation conductor 2 of the radiator 111A of FIG. 44.

FIG. 47 is a graph showing frequency characteristics of S parameters S11 and S21 representing the reflection coefficient and transmission coefficient of the antenna apparatus of FIG. 44.

FIG. 48 is a table showing frequency characteristics of the S parameter S11 representing the reflection coefficient of the antenna apparatus of FIG. 44.

FIG. 49 is a table showing a radiation efficiency of the antenna apparatus of FIG. 44.

FIG. 50 is a perspective view showing an antenna apparatus according to a comparison example of the fourth embodiment of the present invention.

FIG. 51 is an unfolded view showing a detailed configuration of a radiator 220A of the antenna apparatus of FIG. 50.

FIG. 52 is a graph showing frequency characteristics of S parameters S11 and S21 representing the reflection coefficient and transmission coefficient of the antenna apparatus of FIG. 50.

FIG. 53 is a perspective view showing an antenna apparatus according to a fifth embodiment of the present invention.

FIG. 54 is an unfolded view showing a circuit of a radiator 131 of FIG. 53.

FIG. 55 is an unfolded view showing a detailed configuration of radiation conductors 41, 42, 43, 44, and 45 of the radiator 131 of FIG. 53.

FIG. 56 is a diagram showing an equivalent circuit of the radiator 131 of FIG. 53.

FIG. 57 is an unfolded view showing a circuit of a radiator 132 of FIG. 53.

FIG. 58 is an unfolded view showing a detailed configuration of radiation conductors 51, 52, 53, and 54 of the radiator 132 of FIG. 53.

FIG. 59 is a diagram showing an equivalent circuit of the radiator 132 of FIG. 53.

FIG. 60 is a table showing VSWRs of the radiators 131 and 132 of FIG. 53.

FIG. 61 is a table showing radiation efficiencies of the radiators 131 and 132 of FIG. 53.

FIG. 62 is a schematic diagram showing an antenna apparatus according to an eleventh modified embodiment of the first embodiment of the present invention.

FIG. 63 is a schematic diagram showing an antenna apparatus according to a twelfth modified embodiment of the first embodiment of the present invention.

FIG. 64 is a block diagram showing a configuration of a wireless communication apparatus according to a sixth embodiment of the present invention, the wireless communication apparatus being provided with an antenna apparatus of FIG. 1.

### DESCRIPTION OF EMBODIMENTS

Embodiments of the present invention will be described below with reference to the drawings. Note that like components are denoted by the same reference signs.

### First Embodiment

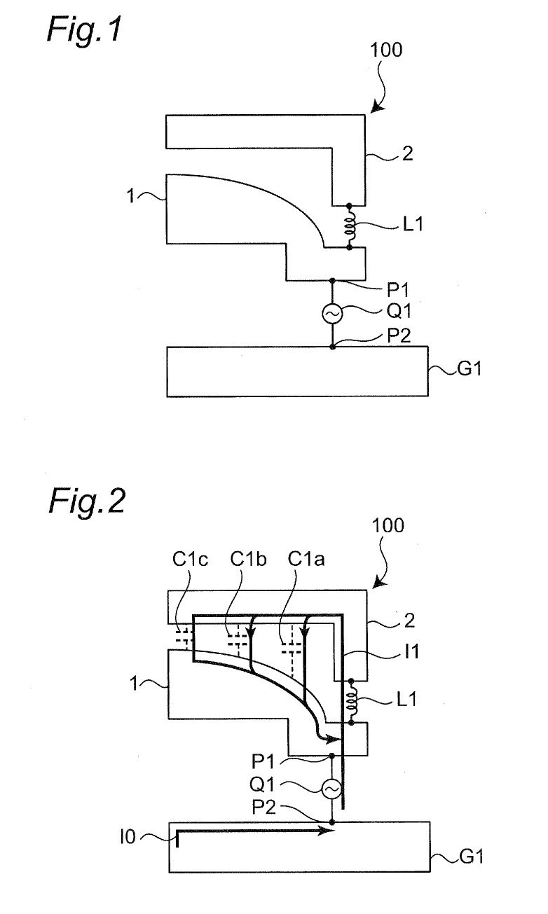

FIG. 1 is a schematic diagram showing an antenna apparatus according to a first embodiment of the present invention. The antenna apparatus of FIG. 1 uses a single radiator 100 for dual-band operation.

Referring to FIG. 1, the radiator 100 has a substantially looped radiation conductor including a first radiation conductor 1 and a second radiation conductor 2, each of the radiation conductor 1 and 2 having a certain width and a certain electrical length. The radiator 100 further has an inductor L1 connecting the radiation conductors 1 and 2 to each other at a certain position along a loop of the radiation conductor. The radiator 100 further has a capacitor formed by a capacitance between the radiation conductors 1 and 2. Therefore, in the radiator 100, a loop surrounding a central hollow portion is formed by the radiation conductors 1 and 2, the inductor L1, and the capacitor between the radiation conductors 1 and 2. In other words, the capacitor is inserted at a position along the looped radiation conductor, and the inductor L1 is inserted at a position different from the position where the capacitor is inserted. The capacitance between the radiation conductors 1 and 2 varies depending on the positions on the radiation conductors 1 and 2 within a portion where the radiation conductors 1 and 2 are close to each other. In FIGS. 2 to 4, for the purpose of explanation, the capacitance varying depending on the positions is shown as virtual capacitors C1a to C1c. However, in fact, it can be considered that between the radiation conductors 1 and 2, there are an infinite number of virtual capacitors having a capacitance continuously varying depending on their positions. A signal source Q1 generates radio-frequency signals with a low-band resonance frequency f1 and a high-band resonance frequency f2, and the signal source Q1 is connected to a feed point P1 on the radiation conductor 1, and connected to a connecting point P2 on a ground conductor G1 close to the radiator 100. The signal source Q1 schematically shows a wireless communication circuit connected to the antenna apparatus of FIG. 1, and excites the radiator 100 at one of the low-band resonance frequency f1 and the high-band resonance frequency f2. If necessary, a matching circuit (not shown) may be further connected between the antenna apparatus and the wireless communication circuit. In the radiator 100, a current path for the case where the radiator 100 is excited at the low-band resonance frequency f1 differs from a current path for the case where the radiator 100 is excited at the high-band resonance frequency f2, and thus, it is possible to effectively achieve dual-band operation.

At first, with reference to FIGS. 5 to 9, the operating principle of the antenna apparatus of FIG. 1 will be described. FIG. 5 is a schematic diagram showing an antenna apparatus according to a first comparison example for explaining the operating principle of the present invention. A radiator 200 of the antenna apparatus of FIG. 5 has a discrete capacitor C1, instead of the capacitor formed by the capacitance between the radiation conductors 1 and 2 of FIG. 1. The radiator 200 has: a first radiation conductor 201 and a second radiation conductor 202, each of the radiation conductor 201 and 202 having a certain width and a certain electrical length; the capacitor C1 connecting the radiation conductors 201 and 202 to each other at a certain position; and an inductor L1 connecting the radiation conductors 201 and 202 to each other at a position different from that of the capacitor C1. In the radiator 200, a loop surrounding a central hollow portion is formed by the radiation conductors 201 and 202, the capacitor C1, and the inductor L1. In other words, the capacitor C1 is inserted at a position along a looped radiation conductor, and the inductor L1 is inserted at a position different from the position where the capacitor C1 is inserted. A signal source Q1 is connected to a feed point P1 on the radiation conductor 201, and connected to a connecting point P2 on a ground conductor G1 close to the radiator 200.

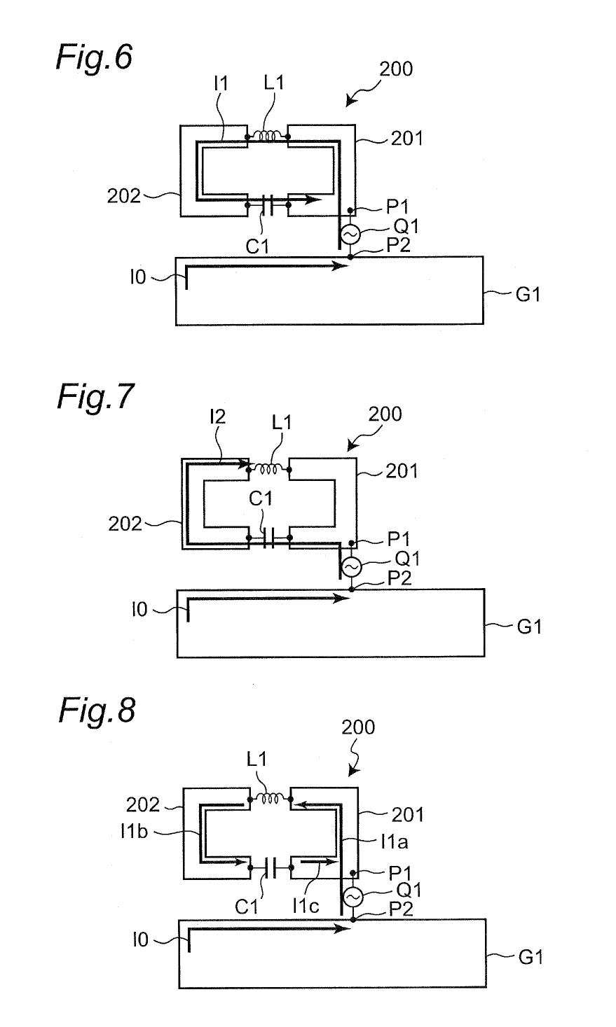

FIG. 6 is a diagram showing a current path for the case where the antenna apparatus of FIG. 5 operates at the low-band resonance frequency f1. By nature, a current having a low frequency component can pass through an inductor (low impedance), but is difficult to pass through a capacitor (high impedance). Hence, a current I1, for the case where the antenna apparatus operates at the low-band resonance frequency f1, flows through a path along the looped radiation conductor, the path including the inductor L1. Specifically, the current I1 flows through a portion of the radiation conductor 201 from the feed point P1 to a point connected to the inductor L1, and passes through the inductor L1, and then, flows through a portion of the radiation conductor 202 from a point connected to the inductor L1, to a point connected to the capacitor C1. Further, due to a voltage difference across both ends of the capacitor C1, a current flows through a portion of the radiation conductor 201 from a point connected to the capacitor C1, to the feed point P1, and is connected to the current I1. Hence, it can be considered that the current I1 substantially also passes through the capacitor C1. The current I1 strongly flows along an inner edge of the looped radiation conductor, close to the central hollow portion. In addition, a current I0 flows along a portion on the ground conductor G1, the portion being close to the radiator 200, and flows toward the connecting point P2. The radiator 200 is configured such that when the antenna apparatus operates at the low-band resonance frequency f1, the current I1 flows through the current path as shown in FIG. 2, and a portion of the radiator 200, including the looped radiation conductor, the inductor L1, and the capacitor C1, resonates at the low-band resonance frequency f1. Specifically, the radiator 200 is configured such that the sum of electrical lengths, including an electrical length of the portion of the radiation conductor 201 from the feed point P1 to the point connected to the inductor L1, an electrical length of the portion of the radiation conductor 201 from the feed point P1 to the point connected to the capacitor C1, an electrical length of the inductor L1, an electrical length of the capacitor C1, and an electrical length of the portion of the radiation conductor 202 from the point connected to the inductor L1 to the point connected to the capacitor C1, is an electrical length at which the radiator 200 resonates at the low-band resonance frequency f1. The electrical length at which the radiator 200 resonates is, for example, 0.2 to 0.25 times of an operating wavelength λ1 of the low-band resonance frequency f1. When the antenna apparatus operates at the low-band resonance frequency f1, the current I1 flows through the current path as shown in FIG. 2, and accordingly, the radiator 200 operates in a loop antenna mode, i.e., a magnetic current mode.

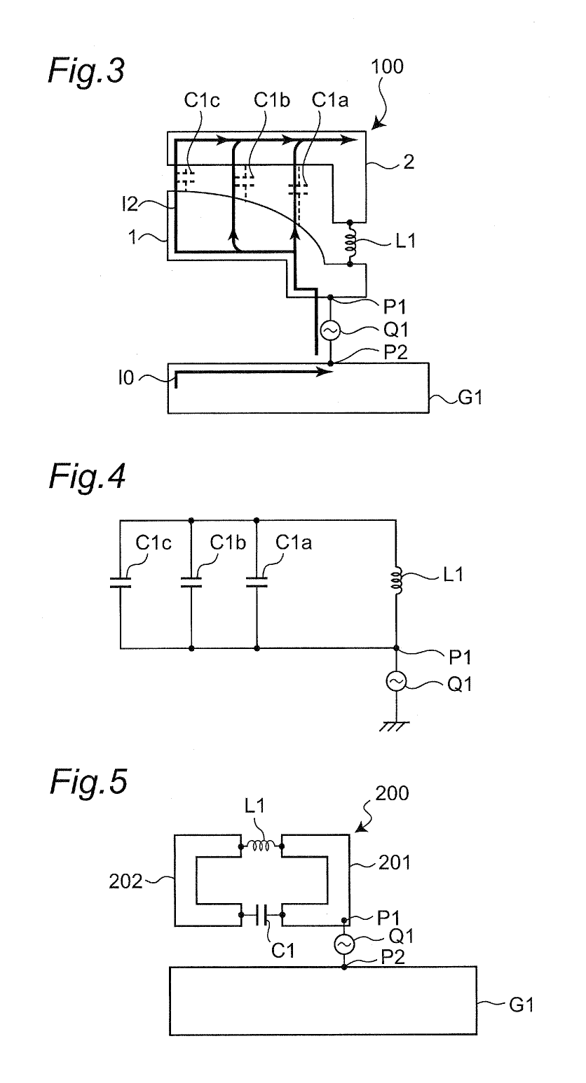

FIG. 7 is a diagram showing a current path for the case where the antenna apparatus of FIG. 5 operates at the high-band resonance frequency f2. By nature, a current having a high frequency component can pass through a capacitor (low impedance), but is difficult to pass through an inductor (high impedance). Hence, a current I2, for the case where the antenna apparatus operates at the high-band resonance frequency f2, flows through a section along the looped radiation conductor, the section including the capacitor C1, not including the inductor L1, and extending between the feed point and the inductor. Specifically, the current I2 flows through a portion of the radiation conductor 201 from the feed point P1, to a point connected to the capacitor C1, and passes through the capacitor C1, and flows through a portion of the radiation conductor 202 from a point connected to the capacitor C1, to a certain position (e.g., a point connected to the inductor L1). At this time, the current I2 strongly flows along an outer edge of the looped radiation conductor. A current I0 flows along a portion on the ground conductor G1, the portion being close to the radiator 200, and flows toward the connecting point P2 (i.e., in an opposite direction to that of the current I2). The radiator 200 is configured such that when the antenna apparatus operates at the high-band resonance frequency f2, the current I2 flows through a current path as shown in FIG. 3, and a portion of the radiator 200, including a portion of the looped radiation conductor through which the current I2 flows, and including the capacitor C1, resonates at the high-band resonance frequency f2. Specifically, the radiator 200 is configured such that the sum of electrical lengths, including an electrical length of the portion of the radiation conductor 201 from the feed point P1 to the point connected to the capacitor C1, an electrical length of the capacitor C1, and an electrical length of the portion of the radiation conductor 202 through which the current I2 flows (e.g., an electrical length from the point connected to the capacitor C1 to the point connected to the inductor L1), is an electrical length at which the radiator 200 resonates at the high-band resonance frequency f2. The electrical length at which the radiator 200 resonates is, for example, 0.25 times of an operating wavelength λ2 of the high-band resonance frequency f2. When the antenna apparatus operates at the high-band resonance frequency f2, the current I2 flows through the current path as shown in FIG. 3, and accordingly, the radiator 200 operates in a monopole antenna mode, i.e., an electric current mode.

As described above, the antenna apparatus of FIG. 5 forms the current path passing through the inductor L1 when operating at the low-band resonance frequency f1, and forms the current path passing through the capacitor C1 when operating at the high-band resonance frequency f2, thus effectively achieving dual-band operation. The radiator 200 operates in the magnetic current mode by forming a looped current path, and resonates at the low-band resonance frequency f1. On the other hand, the radiator 200 operates in the electric current mode by forming a non-looped current path (monopole antenna mode), and resonates at the high-band resonance frequency f2.

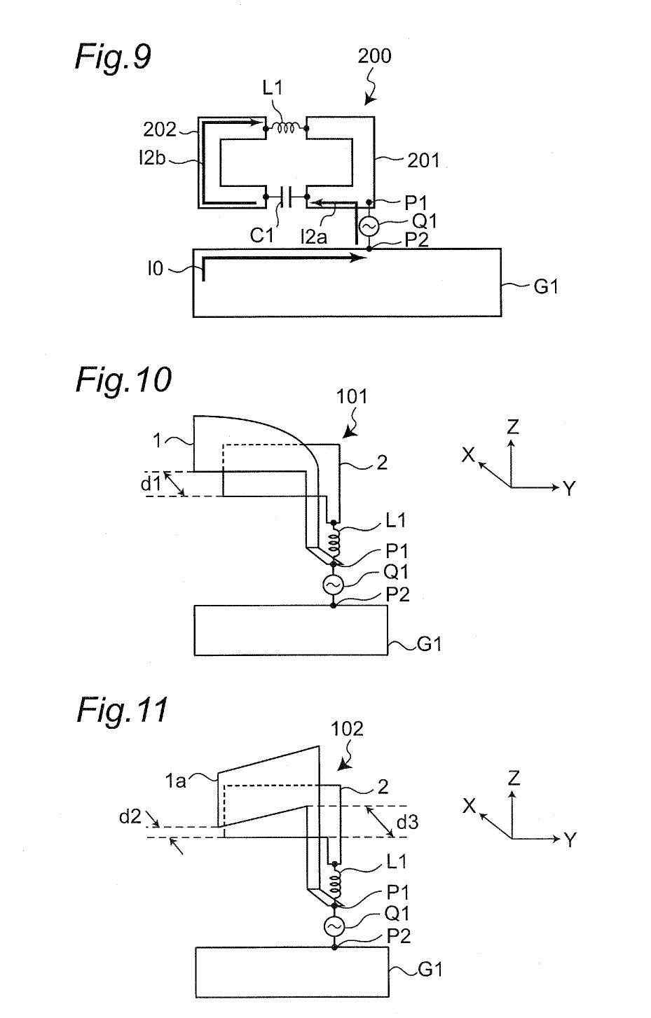

FIG. 8 is a diagram for explaining a matching effect brought about by the inductor L1 and the capacitor C1 for the case where the antenna apparatus of FIG. 5 operates at the low-band resonance frequency f1. FIG. 9 is a diagram for explaining a matching effect brought about by the inductor L1 and the capacitor C1 for the case where the antenna apparatus of FIG. 5 operates at the high-band resonance frequency f2. The low-band resonance frequency f1 and the high-band resonance frequency f2 can be adjusted using the matching effects brought about by the inductor L1 and the capacitor C1 (in particular, matching effects brought about by the capacitor C1). When the antenna apparatus operates at the low-band resonance frequency f1, a current I1b flowing through the portion of the radiation conductor 202 from the point connected to the inductor L1 to the point connected to the capacitor C1, and a current I1c flowing through the portion of the radiation conductor 201 from the point connected to the capacitor C1 to the feed point P1 are connected to a current I1a flowing through the portion of the radiation conductor 201 from the feed point P1 to the point connected to the inductor L1, and thus, a looped current path is formed. Since the voltage difference appears across both ends of the capacitor C1 (on the side of the radiation conductor 201 and the side of the radiation conductor 202), there is an advantageous effect that the reactance component of the input impedance of the antenna apparatus is controlled using the capacitance of the capacitor C1. The larger the capacitance of the capacitor C1, the lower the resonance frequency of the radiator 200. On the other hand, when the antenna apparatus operates at the high-band resonance frequency f2, a current flows through the portion of the radiation conductor 201 from the feed point P1 to the point connected to the capacitor C1 (current I2a), and passes through the capacitor C1, and flows through the portion of the radiation conductor 202 from the point connected to the capacitor C1 to the point connected to the inductor L1 (current I2b). Since the capacitor C1 passes a high frequency component, reduction in the capacitance of the capacitor C1 results in a shortened electrical length, and thus, the resonance frequency of the radiator 200 shifts to a higher frequency. Since the voltage at the feed point P1 is the minimum in the radiator 200, the resonance frequency of the radiator 200 can be decreased by increasing a distance of the capacitor C1 from the feed point P1.

On the other hand, the antenna apparatus of FIG. 1 is provided with a capacitor having a capacitance variable depending on its position, instead of the capacitor C1 of the antenna apparatus of FIG. 5, thus achieving a wider operating bandwidth of the antenna apparatus.

FIG. 2 is a diagram showing a current path for the case where the antenna apparatus of FIG. 1 operates at the low-band resonance frequency f1. FIG. 4 is a diagram showing an equivalent circuit of the antenna apparatus of FIG. 1. A current I1, for the case where the antenna apparatus operates at the low-band resonance frequency f1, flows through a path along the looped radiation conductor, the path including the inductor L1. Specifically, the current I1 flows through a portion of the radiation conductor 1 from the feed point P1, to a point connected to the inductor L1, and passes through the inductor L1, and then flows through a portion of the radiation conductor 2 from a point connected to the inductor L1, to a position where a certain capacitance is formed between the radiation conductors 1 and 2 (e.g., a position where a virtual capacitor C1a is formed). Further, due to a voltage difference across the radiation conductors 1 and 2 at the position, a current flows from a corresponding position on the radiation conductor 1, to the feed point P1, and is connected to the current I1. Hence, it can be considered that the current I1 substantially also passes through the capacitor between the radiation conductors 1 and 2 (e.g., one of the virtual capacitors C1a to C1c). The current I1 flows strongly along an inner edge of the looped radiation conductor, close to the central hollow portion. In addition, a current I0 flows along a portion on the ground conductor G1, the portion being close to the radiator 100, and flows toward the connecting point P2. The radiator 100 is configured such that when the antenna apparatus operates at the low-band resonance frequency f1, the current I1 flows through the current path as shown in FIG. 2 (a current path passing through one of the virtual capacitors C1a to C1c), and a portion of the radiator 100, including the looped radiation conductor, the inductor L1, and the capacitor between the radiation conductors 1 and 2, resonates at the low-band resonance frequency f1. Specifically, the radiator 100 is configured such that the sum of electrical lengths, including an electrical length of the portion of the radiation conductor 1 from the feed point P1 to the point connected to the inductor L1, an electrical length of the inductor L1, an electrical length of the capacitor formed by the capacitance between certain positions on the radiation conductors 1 and 2, an electrical length of the portion of the radiation conductor 2 from the point connected to the inductor L1 to the position of the capacitor, and an electrical length of the portion of the radiation conductor 1 from the feed point P1 to the position of the capacitor, is an electrical length at which the radiator 100 resonates at the low-band resonance frequency f1. The electrical length at which the radiator 100 resonates is, for example, 0.2 to 0.25 times of the operating wavelength λ1 of the low-band resonance frequency f1.

When the antenna apparatus operates at the low-band resonance frequency f1, the current I1 flows through the current path as shown in FIG. 2, and accordingly, the radiator 100 operates in a loop antenna mode, i.e., a magnetic current mode. Since the radiator 100 operates in the loop antenna mode, it is possible to achieve a long resonant length while maintaining a compact form, thus achieving good characteristics even when the antenna apparatus operates at the low-band resonance frequency f1. In addition, when the radiator 100 operates in a loop antenna mode, the radiator 100 has a high Q factor. The wider the central hollow portion of the looped radiation conductor is (i.e., the larger the diameter of the loop is), the more the radiation efficiency of the antenna apparatus improves.

Further, since a capacitor between the radiation conductors 1 and 2, i.e., a capacitor having a capacitance variable depending on the positions resonates, the operating bandwidth of the low-band frequencies of the radiator 100 increases.

FIG. 3 is a diagram showing a current path for the case where the antenna apparatus of FIG. 1 operates at the high-band resonance frequency f2. A current I2, for the case where the antenna apparatus operates at the high-band resonance frequency f2, flows through a section along the looped radiation conductor, the section including the capacitor between the radiation conductors 1 and 2, not including the inductor L1, and extending between the feed point P1 and the inductor L1. Specifically, the current I2 flows through a portion of the radiation conductor 1 from the feed point P1, to a position where a certain capacitance is formed between the radiation conductors 1 and 2 (e.g., a position where a virtual capacitor C1a is formed), and passes through the capacitor between the radiation conductors 1 and 2 at the position to the radiation conductor 2, and then flows to a certain position on the radiation conductor 2 (e.g., a corner point of the radiation conductor 2). At this time, the current I2 strongly flows along an outer edge of the looped radiation conductor. A current I0 flows through a portion on the ground conductor G1, the portion being close to the radiator 100, and flows toward the connecting point P2 (i.e., in an opposite direction to that of the current I2). The radiator 100 is configured such that when the antenna apparatus operates at the high-band resonance frequency f2, the current I2 flows through the current path as shown in FIG. 3 (a current path passing through one of the virtual capacitors C1a to C1c), and a portion of the radiator 100, including a portion of the looped radiation conductor through which the current I2 flows, and including the capacitor between the radiation conductors 1 and 2, resonates at the high-band resonance frequency f2. Specifically, the radiator 100 is configured such that the sum of electrical lengths, including an electrical length of the capacitor formed by the capacitance between certain positions on the radiation conductors 1 and 2, an electrical length of the portion of the radiation conductor 1 from the feed point P1 to the position of the capacitor, and an electrical length of the portion of the radiation conductor 2 through which the current I2 flows (e.g., an electrical length from the position of the capacitor to the corner point of the radiation conductor 2), is an electrical length at which the radiator 100 resonates at the high-band resonance frequency f2. The electrical length at which the radiator 100 resonates is, for example, 0.25 times of the operating wavelength λ2 of the high-band resonance frequency f2.

When the antenna apparatus operates at the high-band resonance frequency f2, the current I2 flows through the current path as shown in FIG. 3, and accordingly, the radiator 100 operates in a monopole antenna mode, i.e., an electric current mode. Further, since a capacitor between the radiation conductors 1 and 2, i.e., a capacitor having a capacitance variable depending on the positions resonates, the operating bandwidth of the high-band frequencies of the radiator 100 increases.

As described above, the antenna apparatus of FIG. 1 forms the current path passing through the inductor L1 when operating at the low-band resonance frequency f1, and fauns the current path passing through the capacitor between the radiation conductors 1 and 2 when operating at the high-band resonance frequency f2, thus effectively achieving dual-band operation. The radiator 100 operates in the magnetic current mode by forming a looped current path, and resonates at the low-band resonance frequency f1. On the other hand, the radiator 100 operates in the electric current mode by forming a non-looped current path (monopole antenna mode), and resonates at the high-band resonance frequency f2.

In addition, the antenna apparatus of FIG. 1 has a special advantageous effect that the antenna apparatus can operate over a wide bandwidth at both low-band frequencies and high-band frequencies.

A method of adjusting the resonance frequency of the antenna apparatus can be summarized as follows. In order to decrease the low-band resonance frequency f1, it is effective to increase the capacitance of the capacitor between the radiation conductors 1 and 2, increase the inductance of the inductor L1, increase the electrical length of the radiation conductor 1, increase the electrical length of the radiation conductor 2, and so forth. In order to decrease the high-band resonance frequency f2, it is effective to increase the electrical length of the radiation conductor 2, increasing a distance of the capacitor between the radiation conductors 1 and 2 from the feed point P1, and so forth.

In order to certainly switch the operation of the antenna apparatus between the magnetic current mode and the electric current mode, the respective current paths for the case where the antenna apparatus operates at the low-band resonance frequency f1 and the high-band resonance frequency f2 should have distinctly different electrical lengths from each other. To this end, the electrical length of the radiation conductor 2 is preferably longer than that of the radiation conductor 1. In addition, suppose that the electrical lengths on the radiation conductor 1 from the feed point P1 to the inductor L1, and from the feed point P1 to the capacitor between the radiation conductors 1 and 2 are shortened. In this case, a current is apt to flow from the feed point P1 to the inductor L1 when the antenna apparatus operates at the low-band resonance frequency f1, and to flow from the feed point P1 to the capacitor when the antenna apparatus operates at the high-band resonance frequency f2, and thus, a current flowing in an unnecessary direction is less likely to occur.

According to the prior art, when an antenna apparatus operates at the low-band resonance frequency f1 (operating wavelength λ1), an antenna element length of about (λ1)/4 is required. On the other hand, since the antenna apparatus of FIG. 1 forms the looped current path, the lengths of the radiator 100 in horizontal and vertical directions can be reduced to about (λ1)/15.

In addition, since the antenna apparatus of FIG. 1 does not require the capacitor C1 of the antenna apparatus of FIG. 5, there is an advantageous effect that a number of parts can be reduced.

As to an antenna apparatus provided with a looped radiation conductor, and a capacitor and an inductor which are inserted at certain positions along a loop of the radiation conductor, for example, there has been an invention of Patent Literature 3. However, according to the invention of Patent Literature 3, a parallel resonant circuit is formed by a capacitor and an inductor, and the parallel resonant circuit operates in one of a basic mode and a higher-order mode according to a frequency. On the other hand, the invention of this application is based on a completely novel principle that the radiator 100 operates in one of a loop antenna mode and a monopole antenna mode according to the operating frequency.

The radiation efficiency of the antenna apparatus can be improved by increasing a distance of the inductor L1 from the capacitor between the radiation conductors 1 and 2 to form a large loop in the radiator 100.

The antenna apparatus of FIG. 1 may use frequencies in the 800 MHz band (e.g., 880 MHz) as the low-band resonance frequency f1, and use frequencies in the 2000 MHz band (e.g., 2170 MHz) as the high-band resonance frequency f2, but not limited thereto.

In FIG. 1, etc., the ground conductor G1 is shown in a small size for ease of illustration. However, those skilled in the art will appreciate that a sufficiently large ground conductor G1 as shown in FIG. 38, etc. is used according to desired performance. The antenna apparatus of FIG. 1 and antenna apparatuses of other embodiments and modified embodiments may be formed on a printed circuit board. In this case, the radiator 100 and the ground conductor G1 are formed as conductive patterns on a dielectric board. Further, the antenna apparatus of FIG. 1 is shown such that the radiator 100 is coplanar with the ground conductor G1, but the arrangement of the radiator 100 and the ground conductor G1 is not limited thereto. For example, a plane including the radiator 100 may have a certain angle with respect to a plane including the ground conductor G1. Further, the radiation conductors 1 and 2 of the radiator 100 may be bent at at least one position.

According to the antenna apparatus of FIG. 1, since the radiator 100 operates in one of the loop antenna mode and the monopole antenna mode according to the operating frequency, it is possible to effectively achieve dual-band operation and reduce size of the antenna apparatus. In addition, the antenna apparatus of FIG. 1 can operate over a wide bandwidth at both low-band frequencies and high-band frequencies.

In order to change the capacitance between the radiation conductors 1 and 2 depending on the positions on the radiation conductors 1 and 2 within a portion where the radiation conductors 1 and 2 are close to each other, it is possible to use various methods such as those shown in FIGS. 10 to 12.

FIG. 10 is a schematic diagram showing an antenna apparatus according to a first modified embodiment of the first embodiment of the present invention. In a radiator 101 of the antenna apparatus of FIG. 10, radiation conductors 1 and 2 are provided in parallel to each other, with a distance d1 therebetween, and have a portion where they are close to each other and overlap each other. Within the portion where the radiation conductors 1 and 2 are close to each other and overlap each other, at least one of the radiation conductors 1 and 2 (in the case of FIG. 10, the radiation conductor 1) has a tapered shape, and areas of sub-portions of the portion divided in a Y-direction vary depending on their positions in the Y-direction on the radiation conductors 1 and 2. Since the areas of the sub-portions vary, the capacitance between the radiation conductors 1 and 2 varies depending on the positions on the radiation conductors 1 and 2 at the portion where the radiation conductors 1 and 2 are close to each other.

FIG. 11 is a schematic diagram showing an antenna apparatus according to a second modified embodiment of the first embodiment of the present invention. A radiator 102 of the antenna apparatus of FIG. 11 has a radiation conductor 1a, instead of the radiation conductor 1 of FIG. 1, and the distance between the radiation conductors 1a and 2 varies depending on the positions in a Y-direction of the radiation conductors 1a and 2 (a distance d2 at −Y edge, and a distance d3 at +Y edge). Referring to FIG. 11, the radiation conductor 1a is shown as planar, but may be curved. Since the distance varies, the capacitance between the radiation conductors 1a and 2 varies depending on the positions on the radiation conductors 1a and 2 within a portion where the radiation conductors 1a and 2 are close to each other.

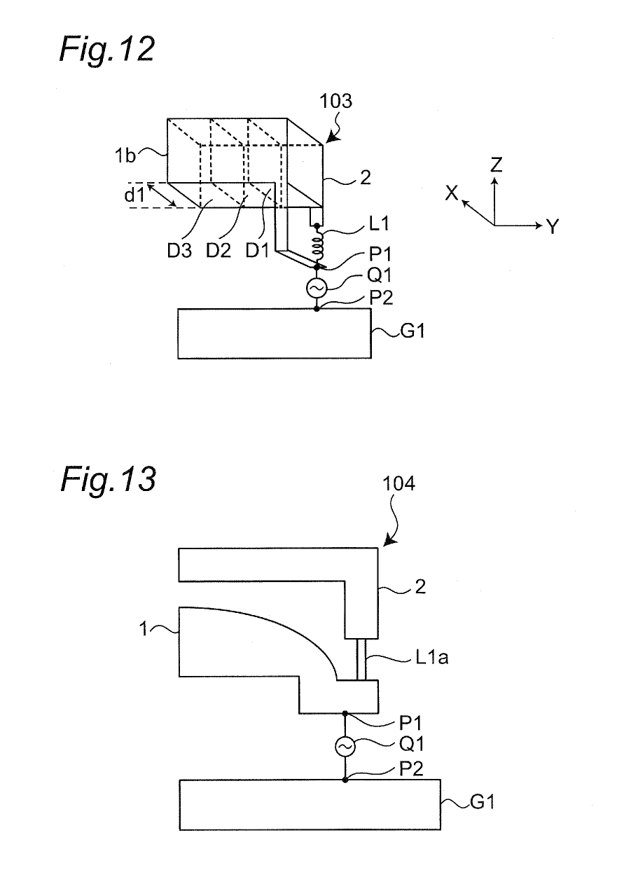

FIG. 12 is a schematic diagram showing an antenna apparatus according to a third modified embodiment of the first embodiment of the present invention. A radiator 103 of the antenna apparatus of FIG. 12 has a radiation conductor 1b, instead of the radiation conductor 1 of FIG. 1, and the radiation conductors 1b and 2 are provided in parallel to each other, with a distance d1 therebetween. Dielectrics D1, D2, and D3 having different dielectric constants are provided between the radiation conductors 1b and 2, and the dielectric constants of the dielectrics D1, D2, and D3 vary depending on the positions in a Y-direction on the radiation conductors 1b and 2 (e.g., D1<D2<D3). The number of dielectrics having different dielectric constants is not limited to 3, and may be 2, or may be 4 or more. Since the dielectric constants vary, the capacitance between the radiation conductors 1b and 2 varies depending on the positions on the radiation conductors 1b and 2 within a portion where the radiation conductors 1b and 2 are close to each other.

In order to change the capacitance between the radiation conductors 1 and 2, the methods of FIGS. 10 to 12 may be combined.

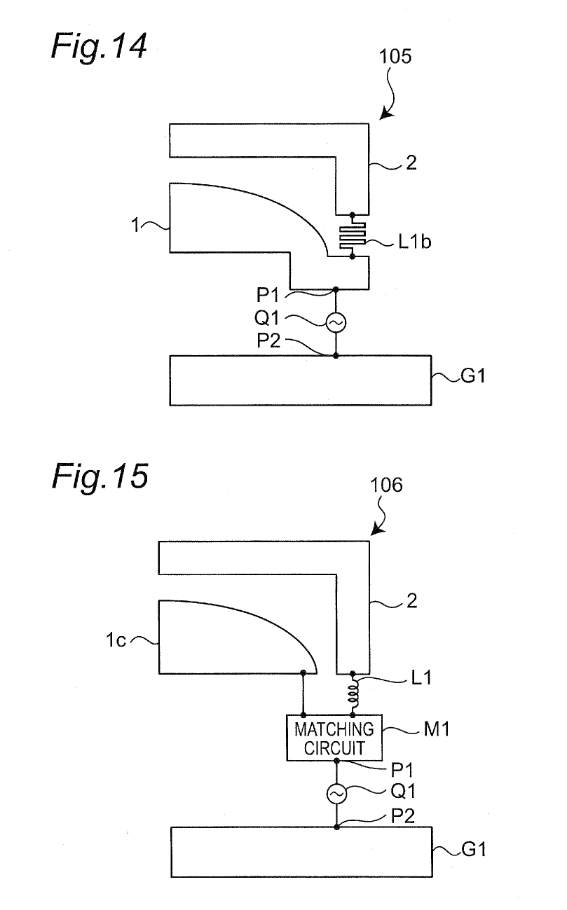

As to the inductor L1, for example, it is possible to use a discrete circuit element, but not limited thereto. FIG. 13 is a schematic diagram showing an antenna apparatus according to a fourth modified embodiment of the first embodiment of the present invention. A radiator 104 of the antenna apparatus of FIG. 13 has an inductor L1a formed as a strip conductor, instead of the inductor L1 of FIG. 1. FIG. 14 is a schematic diagram showing an antenna apparatus according to a fifth modified embodiment of the first embodiment of the present invention. A radiator 105 of the antenna apparatus of FIG. 14 has an inductor L1b formed as a meander conductor, instead of the inductor L1 of FIG. 1. The thinner the width of conductors forming the inductors L1a and L1b and the longer the length of the conductors is, the more the inductance of the inductors L1a and L1b increases. According to the antenna apparatuses of FIGS. 13 and 14, since both a capacitor and an inductor can be formed as conductive patterns on a dielectric board, there are advantageous effects of reduction in cost and reduction in variations of manufacture.

FIG. 15 is a schematic diagram showing an antenna apparatus according to a sixth modified embodiment of the first embodiment of the present invention. In a radiator 106 of the antenna apparatus of FIG. 15, a loop surrounding a central hollow portion is formed by radiation conductors 1c and 2, an inductor L1, and a capacitor between the radiation conductors 1c and 2. The radiator 106 is connected to a feed point P1 through a matching circuit M1. The matching circuit M1 includes, for example, at least one capacitor, at least one inductor, or a combination thereof. Since the antenna apparatus of FIG. 15 includes the matching circuit M1, there is an advantageous effect of improved radiation efficiency.

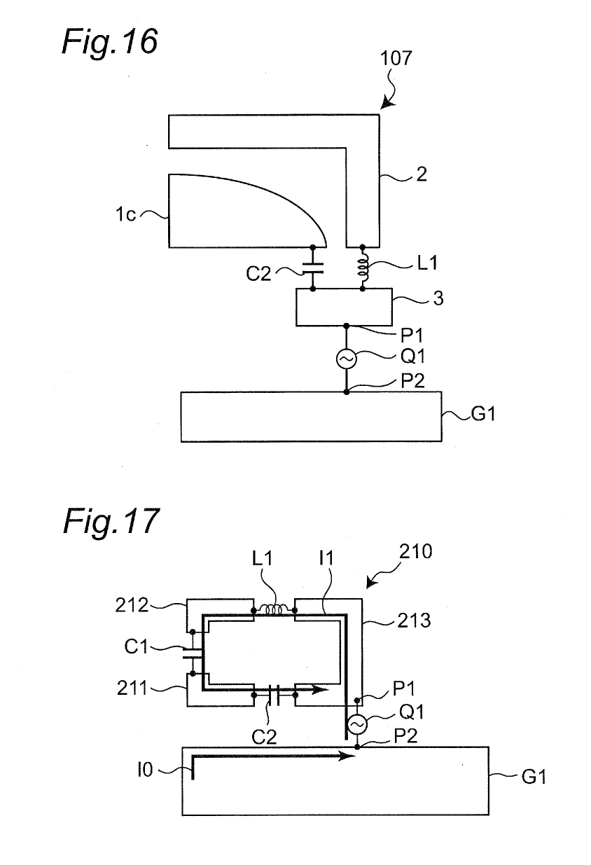

FIG. 16 is a schematic diagram showing an antenna apparatus according to a seventh modified embodiment of the first embodiment of the present invention. In a radiator 107 of the antenna apparatus of FIG. 16, a loop surrounding a central hollow portion is formed by radiation conductors 1c and 2, an inductor L1, a capacitor C2, and a capacitor between the radiation conductors 1c and 2. Therefore, the radiator 107 has two capacitors. The capacitor C2 is inserted at a closer position to a feed point P1 along a looped radiation conductor, than the position of the capacitor between the radiation conductors 1c and 2.

Now, an effect brought about by providing the looped radiation conductor with a plurality of capacitors will be described.

Reducing the capacitance of the capacitor C1 in the antenna apparatus of FIG. 5 results in a wider bandwidth for the case where the antenna apparatus operates at the low-band resonance frequency f1. However, in this case, since the high-band resonance frequency f2 of the antenna apparatus shifts to a higher frequency, the efficiency for the case where the antenna apparatus operates at a desired high-band resonance frequency (or a mid-band resonance frequency which will be described in a second embodiment) decreases. From a different point of view, since the impedance of the capacitor C1, i.e., Z1=1/(j·ω·C1) seen from the feed point P1 is large when the capacitance of the capacitor C1 is reduced, a current I2 for the case where the antenna apparatus operates at the high-band resonance frequency f2 becomes difficult to flow, and thus, the efficiency for the high-band resonance frequency f2 decreases. In this case, the capacitance of the capacitor C1 is denoted by C1, and the angular frequency of a current flowing through the capacitor C1 is denoted by ω. On the other hand, when the capacitance of the capacitor C1 is increased, the high-band resonance frequency f2 of the antenna apparatus shifts to a lower frequency, and thus, the efficiency for the case where the antenna apparatus operates at a desired high-band resonance frequency (or a mid-band resonance frequency) is improved. However, the bandwidth for the case where the antenna apparatus operates at the low-band resonance frequency f1 is narrowed, and shifts to a lower frequency band. Therefore, the efficiency for the case where the antenna apparatus operates at a desired low-band resonance frequency decreases. As described above, there is a trade-off between the efficiency for the case where the antenna apparatus operates at the low-band resonance frequency f1, and the efficiency for the case where the antenna apparatus operates at the high-band resonance frequency f2, according to the capacitance of the capacitor C1.

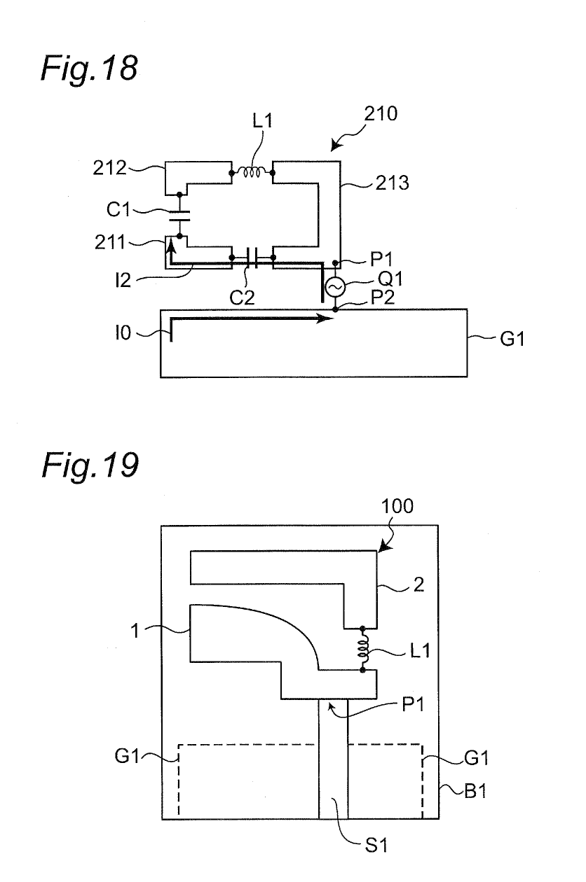

FIG. 17 is a schematic diagram showing an antenna apparatus according to a second comparison example of the present invention for explaining an effect brought about by providing a plurality of capacitors, and showing a current path for the case where the antenna apparatus operates at the low-band resonance frequency f1. FIG. 18 is a diagram showing a current path for the case where the antenna apparatus of FIG. 17 operates at the high-band resonance frequency f2. In a radiator 210 of the antenna apparatus of FIG. 17, a loop surrounding a central hollow portion is formed by radiation conductors 211, 212, and 213, an inductor L1, and capacitors C1 and C2. When the plurality of capacitors C1 and C2 are provided as shown in FIG. 17, the capacitance of the capacitor C2 close to a feed point P1 is made larger than the capacitance of the capacitor C2 remote from the feed point P1 (C2>C1). In particular, the capacitance of the capacitor C2 is configured such that the impedance of the capacitor C2, i.e., Z2=1/(j·ω·C2) is small when the antenna apparatus operates at the high-band resonance frequency f2 (or a mid-band resonance frequency). Thus, a current I2 for the case where the antenna apparatus operates at the high-band resonance frequency f2 (or the mid-band resonance frequency) passes through the capacitor C2 from the feed point P1, and possibly flows at least to the capacitor C1. At this time, due to the radiation resistance of the radiation conductor 211, the efficiency for the case where the antenna apparatus operates at the high-band resonance frequency f2 (or the mid-band resonance frequency) is improved. On the other hand, the capacitance of the capacitor C1 is configured such that the combined impedance of the capacitors C1 and C2, i.e., Z≈1/(j·ω·C1)+1/(j·ω·C2)=1/(j·ω·C) becomes a desired value when the antenna apparatus operates at the low-band resonance frequency f1. In this case, C denotes the combined capacitance of the series-connected capacitors C1 and C2, i.e., C=C1×C2/(C1+C2). Thus, even when the antenna apparatus operates at any one of the low-band resonance frequency f1 and the high-band resonance frequency f2, the efficiency of the antenna apparatus can be improved.

In the antenna apparatus of FIG. 16, the capacitance of the capacitor C2 is made larger than the capacitance of the capacitor between the radiation conductors 1c and 2, according to the principle described with reference to FIGS. 17 and 18. By providing the capacitor C2, it is possible to improve the efficiency of the antenna apparatus even when the antenna apparatus operates at any one of the low-band resonance frequency f1 and the high-band resonance frequency f2.

The antenna apparatus of the present embodiment is not limited to one having a single capacitor (one capacitor between the radiation conductors 1 and 2) and a single inductor as shown in FIG. 1, but may have, for example, two capacitors, like the antenna apparatus of FIG. 16. When a radiator is provided with at least one capacitor and/or at least one inductor inserted at a certain position(s) along a looped radiation conductor, the radiator is configured such that a first portion of the radiator along the looped radiation conductor, including the inductor and the capacitor, resonates at the low-band resonance frequency f1, and a second portion of the radiator including a section along the looped radiation conductor, the section including at least one of the at least one capacitor (e.g., the capacitor C2 of FIG. 16), not including the inductor, and extending between a feed point and the inductor, resonates at the high-band resonance frequency f2. By inserting a capacitor(s) and an inductor(s) at three or more different positions, taking into consideration the current distribution on the radiator, there is an advantageous effect that it is possible to more easily achieve fine adjustments of the low-band resonance frequency f1 and the high-band resonance frequency f2 in the process of design.

In the looped radiation conductor, a capacitor and an inductor can be inserted at various positions. When the capacitor is disposed at a closer position to the ground conductor G1, than the position of the inductor, a current I1 for the case where the antenna apparatus operates at the low-band resonance frequency f1 flows from the feed point P1 to a position on the looped radiation conductor, the position being close to the ground conductor G1, and on the other hand, a current I2 for the case where the antenna apparatus operates at the high-band resonance frequency f2 flows from the feed point P1 to a position on the looped radiation conductor, the position being remote from the ground conductor G1. That is, the open end of the current I1 is close to the ground conductor G1, and on the other hand, the open end of the current I2 is remote from the ground conductor G1. Therefore, the VSWR for the case where the antenna apparatus operates at the high-band resonance frequency f2 is lower than the VSWR for the case where the antenna apparatus operates at the low-band resonance frequency f1, and thus, it becomes easier to achieve matching of the antenna apparatus.

Further, when the inductor is disposed at a closer position to the ground conductor G1, than the position of the capacitor, a current I1 for the case where the antenna apparatus operates at the low-band resonance frequency f1 flows from the feed point P1 to a position on the looped radiation conductor, the position being remote from the ground conductor G1, and on the other hand, a current I2 for the case where the antenna apparatus operates at the high-band resonance frequency f2 flows from the feed point P1 to a position on the looped radiation conductor, the position being close to the ground conductor G1. That is, the open end of the current I2 is close to the ground conductor G1, and on the other hand, the open end of the current I1 is remote from the ground conductor G1. Therefore, the VSWR for the case where the antenna apparatus operates at the low-band resonance frequency f1 is lower than the VSWR for the case where the antenna apparatus operates at the high-band resonance frequency f2, and thus, it becomes easier to achieve matching of the antenna apparatus.

Further, an inductor and a capacitor of a radiator can be provided along a looped radiation conductor such that the inductor and the capacitor are disposed within a portion where the radiation conductor and a ground conductor G1 are close to each other, and a feed point P1 is disposed between the inductor and the capacitor. When both the inductor and the capacitor are close to the ground conductor G1, a radiation conductor where the feed point P1 is provided is shorter compared to the radiation conductor 1 of FIG. 1. Since the radiation conductor on which the feed point P1 is provided is short, it becomes easier to separate a current path for the case where the antenna apparatus operates at the low-band resonance frequency f1, from a current path for the case where the antenna apparatus operates at the high-band resonance frequency f2. In addition, when both the inductor and the capacitor are close to the ground conductor G1, a current I1 for the case where the antenna apparatus operates at the low-band resonance frequency f1 flows from the feed point P1 to a position on the looped radiation conductor, the position being remote from the ground conductor G1, and a current I2 for the case where the antenna apparatus operates at the high-band resonance frequency f2 also flows from the feed point P1 to a position on the looped radiation conductor, the position being remote from the ground conductor G1. That is, both the open ends of the currents I1 and I2 are remote from the ground conductor G1. Therefore, both the VSWRs for the cases where the antenna apparatus operates at the low-band resonance frequency f1 and the VSWR for the case where the antenna apparatus operates at the high-band resonance frequency f2 decrease, and thus, it becomes easier to achieve matching of the antenna apparatus.

It is possible to design a multiband antenna suited for a desired wireless communication apparatus by selecting the positions of an inductor and a capacitor on a looped radiation conductor according to system requirements.

FIG. 19 is a schematic diagram showing an antenna apparatus according to an eighth modified embodiment of the first embodiment of the present invention. FIG. 19 shows an antenna apparatus provided with a feed line as a microstrip line. The antenna apparatus of FIG. 19 is provided with a feed line as a microstrip line, including a ground conductor G1, and a strip conductor S1 provided on the ground conductor G1 with a dielectric board B1 therebetween. The antenna apparatus of FIG. 19 may have a planar configuration for reducing the profile of the antenna apparatus, in other words, the ground conductor G1 may be formed on the back side of a printed circuit board (not shown), and the strip conductor S1 and a radiator 100 may be integrally formed on the front side of the printed circuit board. The feed line is not limited to a microstrip line, and may be a coplanar line, a coaxial line, etc.

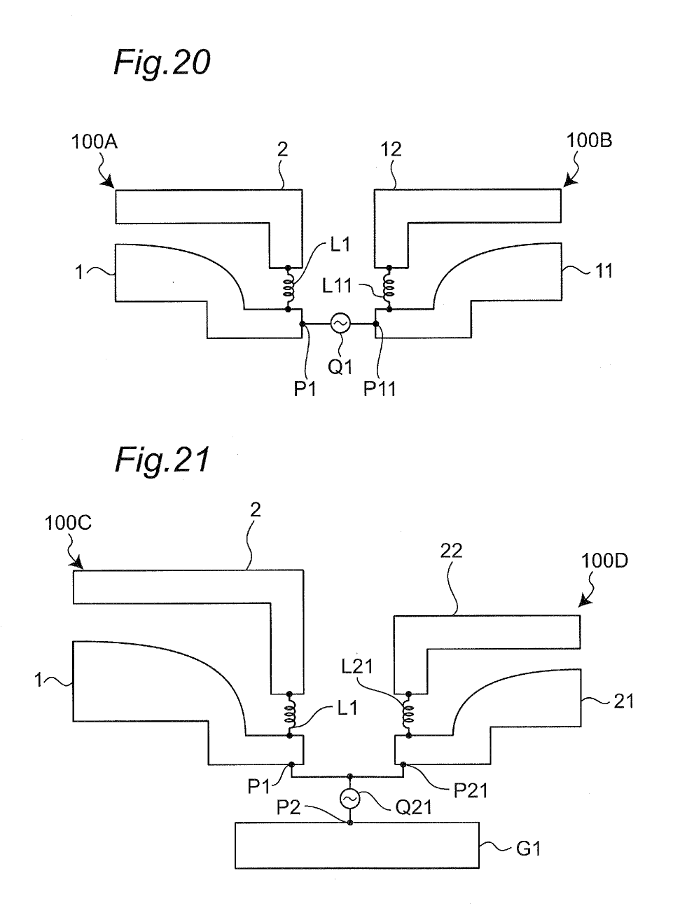

FIG. 20 is a schematic diagram showing an antenna apparatus according to a ninth modified embodiment of the first embodiment of the present invention. FIG. 20 shows an antenna apparatus configured as a dipole antenna. A left radiator 100A of FIG. 20 is configured in the similar manner as that of the radiator 100 of FIG. 1. A right radiator 100B of FIG. 20 is also configured in the similar manner as that of the radiator 100 of FIG. 1, and has a first radiation conductor 11, a second radiation conductor 12, an inductor L11, and a capacitor between the radiation conductors 11 and 12. A signal source Q1 is connected to each of a feed point P1 of the radiator 100A and a feed point P11 of the radiator 100B. The antenna apparatus of FIG. 20 has a dipole configuration, and accordingly, is operable in a balance mode, thus suppressing unwanted radiation.

FIG. 21 is a schematic diagram showing an antenna apparatus according to a tenth modified embodiment of the first embodiment of the present invention. FIG. 21 shows a multiband antenna apparatus operable in 4 bands. A left radiator 100C of FIG. 21 is configured in the similar manner as that of the radiator 100 of FIG. 1. A right radiator 100D of FIG. 21 is also configured in the similar manner as that of the radiator 100 of FIG. 1, and has a first radiation conductor 21, a second radiation conductor 22, an inductor L21, and a capacitor between the radiation conductors 21 and 22. However, the electrical length of a loop formed by the radiation conductors 21 and 22, the inductor L21, and the capacitor between the radiation conductors 21 and 22 of the radiator 100D is different from the electrical length of a loop formed by radiation conductors 1 and 2, an inductor L1, and a capacitor between the radiation conductors 1 and 2 of the radiator 100C. A signal source Q21 is connected to a feed point P1 on the radiation conductor 1 and a feed point P21 on the radiation conductor 21, and is also connected to a connecting point P2 on a ground conductor G1. The signal source Q21 generates radio-frequency signals with a low-band resonance frequency f1 and a high-band resonance frequency f2, and also generates another low-band resonance frequency f21 different from the low-band resonance frequency f1, and another high-band resonance frequency f22 different from the high-band resonance frequency f2. The radiator 100C operates in a loop antenna mode at the low-band resonance frequency f1, and operates in a monopole antenna mode at the high-band resonance frequency f2. In addition, the radiator 100D operates in a loop antenna mode at the low-band resonance frequency f21, and operates in a monopole antenna mode at the high-band resonance frequency f22. Thus, the antenna apparatus of FIG. 21 is capable of multiband operation includes 4 bands. The antenna apparatus of FIG. 21 can achieve multiband operation including further bands, by further providing a radiator.

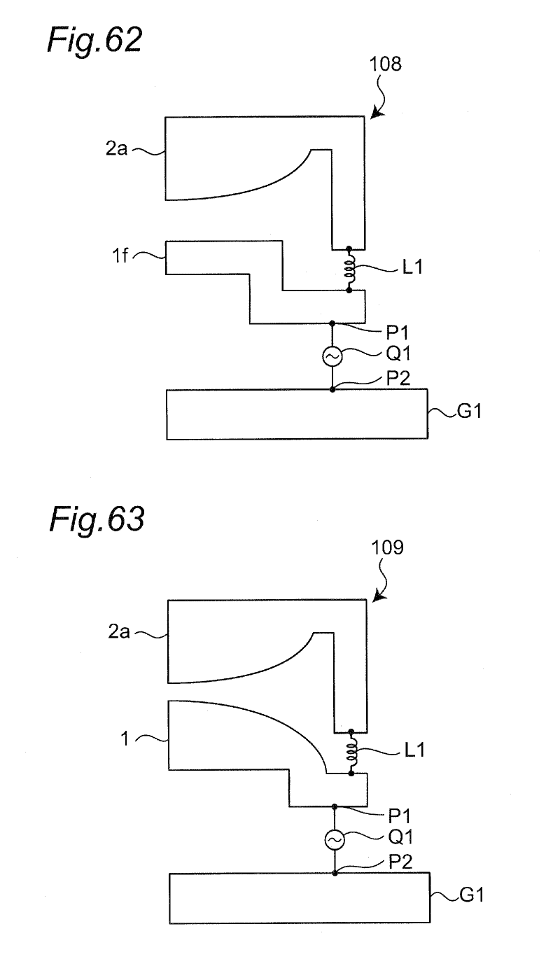

The radiation conductors 1 and 2 are not limited to be shaped as shown in FIG. 1, etc., and may have any shape as long as there is a certain electrical length between the inductor L1 and the capacitor between the radiation conductors 1 and 2. For example, FIG. 62 is a schematic diagram showing an antenna apparatus according to an eleventh modified embodiment of the first embodiment of the present invention. In a radiator 108 of the antenna apparatus of FIG. 62, a loop surrounding a central hollow portion is formed by radiation conductors 1f and 2a, an inductor L1, and a capacitor between the radiation conductors 1f and 2a. FIG. 63 is a schematic diagram showing an antenna apparatus according to a twelfth modified embodiment of the first embodiment of the present invention. In a radiator 109 of the antenna apparatus of FIG. 63, a loop surrounding a central hollow portion is formed by radiation conductors 1 and 2a, an inductor L1, and a capacitor between the radiation conductors 1 and 2a. As shown in FIGS. 1, 62, and 63, at least one of the radiation conductors may be tapered within a portion where the two radiation conductors are close to each other.

Further, as another modified embodiment, an antenna apparatus according to the present embodiment can be configured as an inverted-F antenna apparatus, for example, by providing a radiator including planar or linear radiation conductors in parallel with a ground conductor, and short-circuiting a part of the radiator to the ground conductor (not shown). Short-circuiting a part of the radiator to the ground conductor results in an increased radiation resistance, and it does not impair the basic operating principle of the antenna apparatus according to the present embodiment.

### Second Embodiment

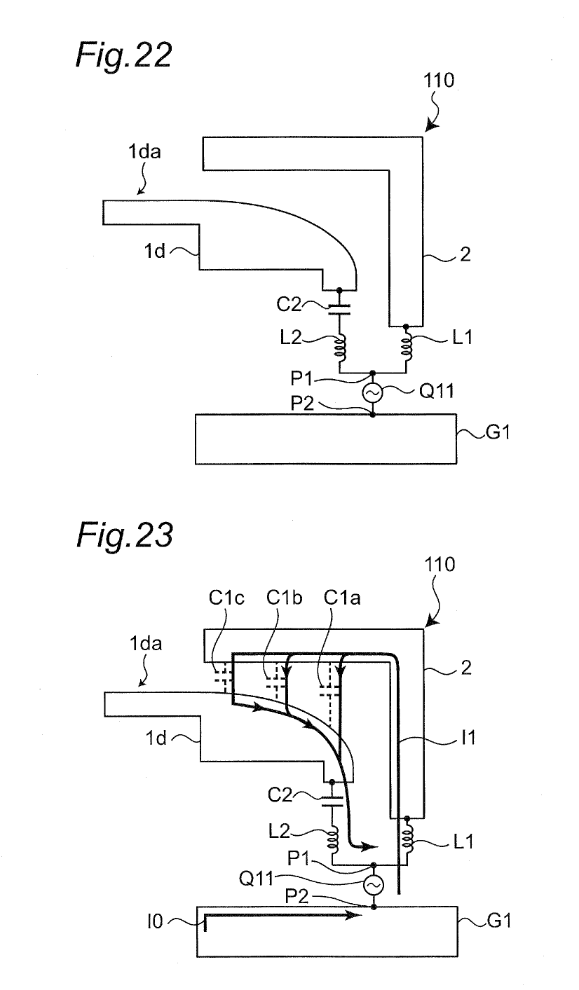

FIG. 22 is a schematic diagram showing an antenna apparatus according to a second embodiment of the present invention. The antenna apparatus of FIG. 22 further has an extension conductor 1da connected to an outer edge of a looped radiation conductor, thus being operable at, in addition to a low-band resonance frequency f1 and a high-band resonance frequency f2, a mid-band resonance frequency f3 therebetween.

Referring to FIG. 22, a radiator 110 has a substantially looped radiation conductor including a first radiation conductor 1d and a second radiation conductor 2, each of the radiation conductors having a certain width and a certain electrical length. The radiator 110 further has a capacitor C2 and inductors L1 and L2 that connect the radiation conductors 1d and 2 to each other at a certain position along a loop of the radiation conductor. The capacitor C2 and the inductors L1 and L2 are connected in series in this order, and a feed point P1 is provided between the inductors L1 and L2. The radiator 110 further has a capacitor formed by a capacitance between the radiation conductors 1d and 2. Therefore, a loop surrounding a central hollow portion is formed by the radiation conductors 1d and 2, the inductors L1 and L2, the capacitor C2, and the capacitor between the radiation conductors 1d and 2. Similar to the capacitor between the radiation conductors 1 and 2 of FIG. 1, the capacitance of the capacitor between the radiation conductors 1d and 2 varies depending on the positions on the radiation conductors 1d and 2 within a portion where the radiation conductors 1d and 2 are close to each other. In FIGS. 23 to 25, the capacitance variable depending on the positions is shown as virtual capacitors C1a to C1c in the similar manner as that of FIGS. 2 to 4. The radiator 110 further has the extension conductor 1da connected to the radiation conductor 1d. The extension conductor 1da is connected to the outer edge of the looped radiation conductor, between the capacitor C2 and the capacitor between the radiation conductors 1d and 2. A signal source Q11 generates radio-frequency signals with the low-band resonance frequency f1, the mid-band resonance frequency f3, and the high-band resonance frequency f2, and the signal source Q11 is connected to the feed point P1 on the radiator 110, and connected to a connecting point P2 on a ground conductor G1 close to the radiator 110. The capacitor C2 and the inductor L2 operate as a matching circuit for finely adjusting the low-band resonance frequency f1, the mid-band resonance frequency f3, and the high-band resonance frequency f2. The inductor L2 is provided particularly for matching of the high-band resonance frequency f2. In the radiator 110, a current path for the case where the radiator 110 is excited at the low-band resonance frequency f1, a current path for the case where the radiator 110 is excited at the mid-band resonance frequency f3, and a current path for the case where the radiator 110 is excited at the high-band resonance frequency f2 differ from one another, and thus, it is possible to effectively achieve triple-band operation.

For example, the antenna apparatus of FIG. 22 may use frequencies in the 800 MHz band as the low-band resonance frequency f1, use frequencies in the 1.5 GHz band as the mid-band resonance frequency f3, and use frequencies in the 2 GHz band as the high-band resonance frequency f2, but not limited thereto.

Note that although FIG. 22 shows the feed point P1 on a portion of the conductor between the inductors L1 and L2, rather than on the radiation conductors 1d and 2, this portion is also considered as a part of the looped radiation conductor in this specification. The radiator 110 may have an additional radiation conductor similar to the radiation conductor 3 of FIG. 16, between the inductors L1 and L2, and a feed point P1 may be provided on the additional radiation conductor.

FIG. 23 is a diagram showing a current path for the case where the antenna apparatus of FIG. 22 operates at the low-band resonance frequency f1. The radiator 110 is configured such that when the antenna apparatus operates at the low-band resonance frequency f1, a current I1 flows through a current path as shown in FIG. 23 (a current path passing through one of the virtual capacitors C1a to C1c), and a portion of the radiator 110, including the looped radiation conductor, the inductors L1 and L2, the capacitor C2, and the capacitor between the radiation conductors 1d and 2 resonates at the low-band resonance frequency f1. When the antenna apparatus operates at the low-band resonance frequency f1, the current I1 flows through the current path as shown in FIG. 23, and accordingly, the radiator 110 operates in a loop antenna mode.

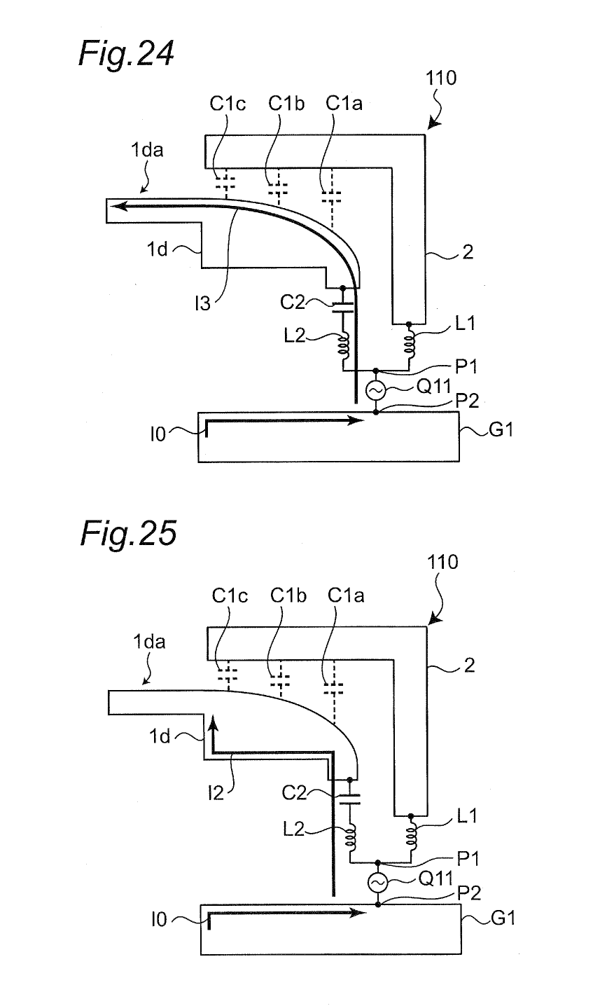

FIG. 24 is a diagram showing a current path for the case where the antenna apparatus of FIG. 22 operates at the mid-band resonance frequency f3. The radiator 110 is configured such that when the antenna apparatus operates at the mid-band resonance frequency f3, a current I3 flows through a current path as shown in FIG. 24, and a portion of the radiator 110 including a section along the looped radiation conductor and including the extension conductor 1da, the section including the capacitor C2, not including the inductor L1, and extending between the feed point P1 and the capacitor between the radiation conductors 1d and 2, resonates at the mid-band resonance frequency f3. When the current I3 flows through the radiation conductor 1d, the current I3 strongly flows along an inner edge of the looped radiation conductor. When the antenna apparatus operates at the mid-band resonance frequency f3, the current I3 flows through the current path as shown in FIG. 24, and accordingly, the radiator 110 operates in a monopole antenna mode (first monopole antenna mode).

FIG. 25 is a diagram showing a current path for the case where the antenna apparatus of FIG. 22 operates at the high-band resonance frequency f2. The radiator 110 is configured such that when the antenna apparatus operates at the high-band resonance frequency f2, a current I2 flows through a current path as shown in FIG. 25, and a portion of the radiator 110 including a section along the looped radiation conductor, the section including the capacitor C2, not including the inductor L1, and extending between the feed point P1 and the capacitor between the radiation conductors 1d and 2 (but not including the extension conductor 1da), resonates at the high-band resonance frequency f2. When the current I2 flows through the radiation conductor 1d, the current I2 strongly flows along an outer edge of the looped radiation conductor, i.e., a portion close to the ground conductor G1. When the antenna apparatus operates at the high-band resonance frequency f2, the current I2 flows through the current path as shown in FIG. 25, and accordingly, the radiator 110 operates in a monopole antenna mode (second monopole antenna mode).

Providing the antenna apparatus of FIG. 22 with the extension conductor 1da results in an increased electrical length along the current I3 for the case where the antenna apparatus operates at the mid-band resonance frequency f3. Therefore, the extension conductor 1da has the advantageous effect of an increased radiation resistance of the radiator 110 for the case where the antenna apparatus operates at the mid-band resonance frequency f3.

In the antenna apparatus of FIG. 22, the capacitance of the capacitor C2 is made larger than the capacitance of the capacitor between the radiation conductors 1d and 2, according to the principle described with reference to FIGS. 17 and 18. By providing the capacitor C2, it is possible to improve the efficiency of the antenna apparatus even when the antenna apparatus operates at any one of the low-band resonance frequency f1, the mid-band resonance frequency f3, and the high-band resonance frequency f2.

According to the antenna apparatus of FIG. 22, since the radiator 110 operates in any one of the loop antenna mode and the first and second monopole antenna modes according to an operating frequency, it is possible to effectively achieve triple-band operation and reduce size of the antenna apparatus. In addition, the antenna apparatus of FIG. 22 can operate over a wide bandwidth at any one of low-band frequencies, mid-band frequencies, and high-band frequencies.

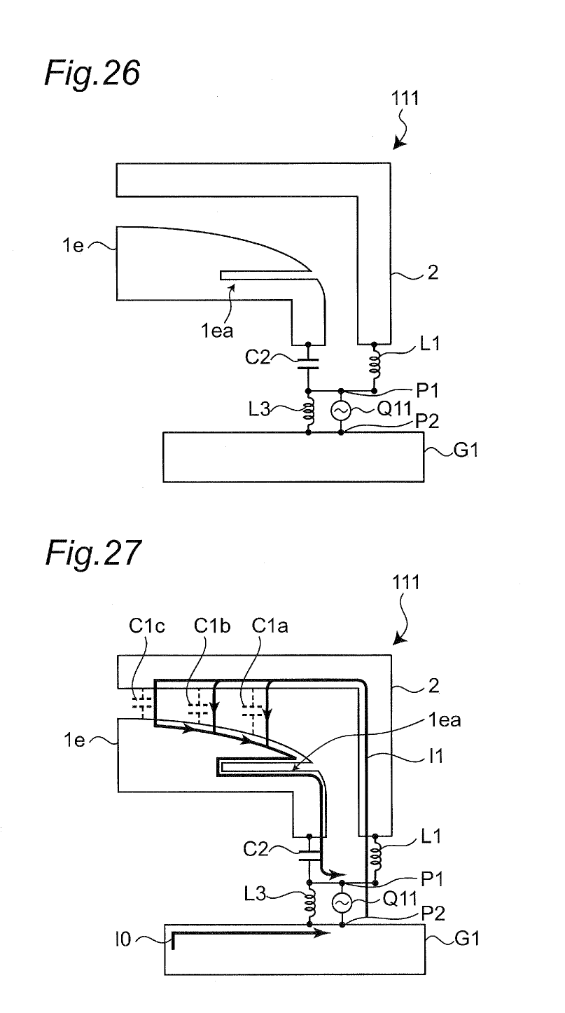

FIG. 26 is a schematic diagram showing an antenna apparatus according to a modified embodiment of the second embodiment of the present invention. The antenna apparatus of FIG. 26 has a slit lea provided at an inner edge of a looped radiation conductor, instead of the extension conductor 1da of FIG. 22, thus being operable at, in addition to a low-band resonance frequency f1 and a high-band resonance frequency f2, a mid-band resonance frequency f3 therebetween.

Referring to FIG. 26, a radiator 111 has a substantially looped radiation conductor including a first radiation conductor 1e and a second radiation conductor 2, each of the radiation conductors having a certain width and a certain electrical length. The radiator 111 further has a capacitor C2 and an inductor L1 that connect the radiation conductors 1e and 2 to each other at a certain position along a loop of the radiation conductor. The capacitor C2 and the inductor L1 are connected in series, and a feed point P1 is provided therebetween. The radiator 111 further has a capacitor formed by a capacitance between the radiation conductors 1e and 2. Therefore, a loop surrounding a central hollow portion is formed by the radiation conductors 1e and 2, the inductor L1, the capacitor C2, and the capacitor between the radiation conductors 1e and 2. Similar to the capacitor between the radiation conductors 1 and 2 of FIG. 1, the capacitance of the capacitor between the radiation conductors 1e and 2 varies depending on the positions on the radiation conductors 1e and 2 within a portion where the radiation conductors 1e and 2 are close to each other. Referring to FIGS. 27 to 29, the capacitance variable depending on the positions is shown as virtual capacitors C1a to C1c in the similar manner as in FIGS. 2 to 4. The radiator 111 further has the slit lea provided in the radiation conductor 1e. The slit lea is provided between the capacitor C2 and the capacitor between the radiation conductors 1e and 2 so as to have an opening at the inner edge of the looped radiation conductor. A signal source Q11 generates radio-frequency signals with the low-band resonance frequency f1, the mid-band resonance frequency f3, and the high-band resonance frequency f2, and the signal source Q11 is connected to the feed point P1 on the radiator 111, and connected to a connecting point P2 on a ground conductor G1 close to the radiator 111. The feed point P1 is further connected to the ground conductor G1 through an inductor L3. The capacitor C2 and the inductor L3 operate as a matching circuit for finely adjusting the low-band resonance frequency f1, the mid-band resonance frequency f3, and the high-band resonance frequency f2. The inductor L3 is provided particularly for matching of the low-band resonance frequency f1. In the radiator 111, a current path for the case where the radiator 111 is excited at the low-band resonance frequency f1, a current path for the case where the radiator 111 is excited at the mid-band resonance frequency f3, and a current path for the case where the radiator 111 is excited at the high-band resonance frequency f2 differ from one another, and thus, it is possible to effectively achieve triple-band operation.

Note that although FIG. 22 shows the feed point P1 on a portion of the conductor between the inductor L1 and the capacitor C2, rather than on the radiation conductors 1e and 2, this position is also considered as a part of the looped radiation conductor in this specification. The radiator 111 may have an additional radiation conductor similar to the radiation conductor 3 of FIG. 16, between the inductor L1 and the capacitor C2, and a feed point P1 may be provided on the additional radiation conductor.

FIG. 27 is a diagram showing a current path for the case where the antenna apparatus of FIG. 26 operates at the low-band resonance frequency f1. The radiator 111 is configured such that when the antenna apparatus operates at the low-band resonance frequency f1, a current I1 flows through a current path as shown in FIG. 27 (a current path passing through one of the virtual capacitors C1a to C1c), and a portion of the radiator 111, including the looped radiation conductor, the inductor L1, the capacitor C2, the capacitor between the radiation conductors 1e and 2, and the slit lea, resonates at the low-band resonance frequency f1. When the antenna apparatus operates at the low-band resonance frequency f1, the current I1 flows through the current path as shown in FIG. 27, and accordingly, the radiator 111 operates in a loop antenna mode.

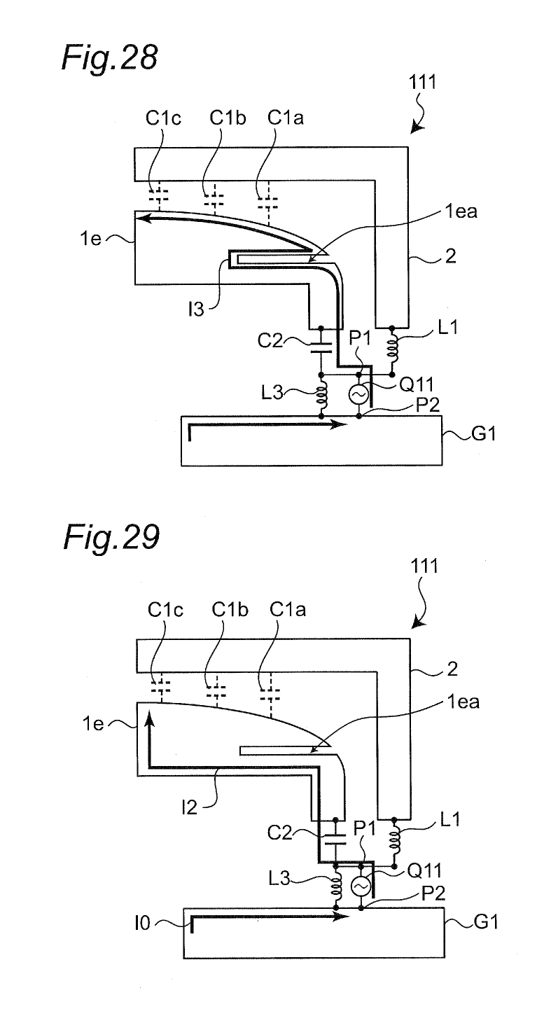

FIG. 28 is a diagram showing a current path for the case where the antenna apparatus of FIG. 26 operates at the mid-band resonance frequency f3. The radiator 111 is configured such that when the antenna apparatus operates at the mid-band resonance frequency f3, a current I3 flows through a current path as shown in FIG. 28, and a portion of the radiator 111 including a section along the looped radiation conductor and including the slit lea, the section including the capacitor C2, not including the inductor L1, and extending between the feed point P1 and the capacitor between the radiation conductors 1e and 2, resonates at the mid-band resonance frequency f3. When the current I3 flows through the radiation conductor 1e, the current I3 strongly flows along the inner edge of the looped radiation conductor. When the antenna apparatus operates at the mid-band resonance frequency f3, the current I3 flows through the current path as shown in FIG. 28, and accordingly, the radiator 111 operates in a monopole antenna mode (first monopole antenna mode).

FIG. 29 is a diagram showing a current path for the case where the antenna apparatus of FIG. 26 operates at the high-band resonance frequency f2. The radiator 111 is configured such that when the antenna apparatus operates at the high-band resonance frequency f2, a current I2 flows through a current path as shown in FIG. 29, and a portion of the radiator 111 including a section along the looped radiation conductor, the section including the capacitor C2, not including the inductor L1, and extending between the feed point P1 and the capacitor between the radiation conductors 1e and 2 (but not including the slit lea), resonates at the high-band resonance frequency f2. When the current I2 flows through the radiation conductor 1e, the current I2 strongly flows along an outer edge of the looped radiation conductor, i.e., a portion close to the ground conductor G1. When the antenna apparatus operates at the high-band resonance frequency f2, the current I2 flows through the current path as shown in FIG. 29, and accordingly, the radiator 111 operates in a monopole antenna mode (second monopole antenna mode).

Providing the antenna apparatus of FIG. 26 with the slit lea results in an increased electrical length along the current I3 for the case where the antenna apparatus operates at the mid-band resonance frequency f3. Therefore, in a similar manner as that of the extension conductor 1da of FIG. 22, the slit lea has the advantageous effect of an increased radiation resistance of the radiator 111 for the case where the antenna apparatus operates at the mid-band resonance frequency f3.

In the antenna apparatus of FIG. 26, the capacitance of the capacitor C2 is made larger than the capacitance of the capacitor between the radiation conductors 1e and 2, according to the principle described with reference to FIGS. 17 and 18. By providing the capacitor C2, it is possible to improve the efficiency of the antenna apparatus even when the antenna apparatus operates at any one of the low-band resonance frequency f1, the mid-band resonance frequency f3, and the high-band resonance frequency f2.

According to the antenna apparatus of FIG. 26, since the radiator 111 operates in any one of the loop antenna mode and the first and second monopole antenna modes according to an operating frequency, it is possible to effectively achieve triple-band operation and reduce size of the antenna apparatus. In addition, the antenna apparatus of FIG. 26 can operate over a wide bandwidth at any one of low-band frequencies, mid-band frequencies, and high-band frequencies.

### Third Embodiment

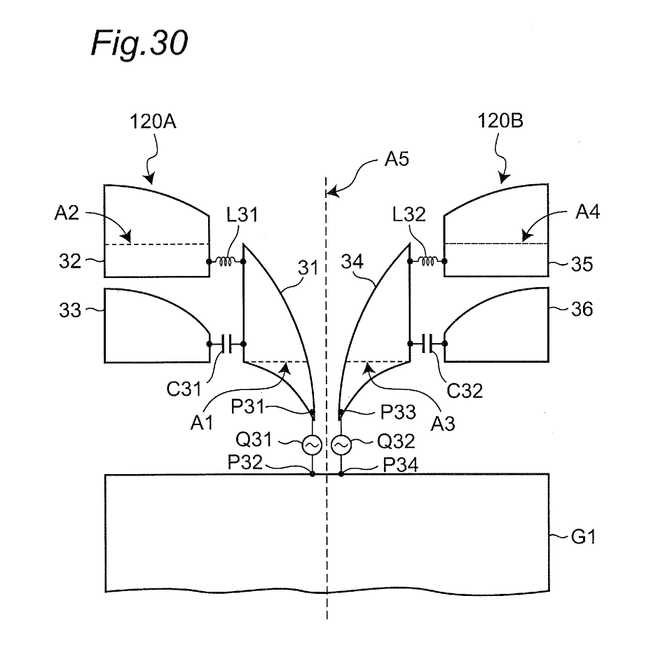

FIG. 30 is a schematic diagram showing an antenna apparatus according to a third embodiment of the present invention. The antenna apparatus of FIG. 30 includes two radiators 120A and 120B configured according to the similar principle as that for the radiator of the first embodiment (e.g., the radiator 107 of FIG. 16), and the radiators 120A and 120B are independently excited by different signal sources Q31 and Q32.

Referring to FIG. 30, the radiator 120A has a substantially looped radiation conductor including a first radiation conductor 31, a second radiation conductor 32, and a third radiation conductor 33, each of the radiation conductors 31, 32 and 33 having a certain electrical length. The radiator 100 further has an inductor L31 connecting the radiation conductors 31 and 32 to each other at a certain position, and a capacitor C31 connecting the radiation conductors 31 and 33 to each other at a certain position. The radiator 100 further has a capacitor formed by a capacitance between the radiation conductors 32 and 33. In the radiator 120A, a loop surrounding a central hollow portion is formed by the radiation conductors 31, 32, and 33, the capacitor C31, the inductor L31, and the capacitor between the radiation conductors 32 and 33. The capacitance between the radiation conductors 32 and 33 varies depending on the positions on the radiation conductors 32 and 33 within a portion where the radiation conductors 32 and 33 are close to each other. The signal source Q31 is connected to a feed point P31 on the radiation conductor 31, and connected to a connecting point P32 on a ground conductor G1 close to the radiator 120A. The radiator 120B is configured in the similar manner as that of the radiator 120A, and has a first radiation conductor 34, a second radiation conductor 35, a third radiation conductor 36, a capacitor C32, an inductor L32, and a capacitor formed by a capacitance between the radiation conductors 35 and 36. In the radiator 120B, a loop surrounding a central hollow portion is formed by the radiation conductors 34, 35, and 36, the capacitor C32, the inductor L32, and the capacitor between the radiation conductors 35 and 36. The signal source Q2 is connected to a feed point P33 on the radiation conductor 34, and connected to a connecting point P34 on the ground conductor G1 close to the radiator 120B. The signal sources Q31 and Q32 generate, for example, radio-frequency signals as transmitting signals of a MIMO communication scheme. The signal sources Q31 and Q32 generate radio-frequency signals with the same low-band resonance frequency f1, and generate radio-frequency signals with the same high-band resonance frequency f2.

The radiators 120A and 120B preferably have radiation conductors formed symmetrically with respect to a reference axis A5. The radiation conductors 31 and 34 and a feed portion (the feed points P31 and P33 and the connecting points P32 and P33) are provided close to the reference axis A5, and the radiation conductors 32, 33, 35, and 36 are provided remote from the reference axis A5. The feed points P31 and P33 are provided at positions symmetric with respect to the reference axis A5. The radiation conductors of the radiators 120A and 120B are shaped such that a distance between the radiators 120A and 120B gradually increases as a distance from the feed points P31 and P33 increases, and accordingly, it is possible to reduce the electromagnetic coupling between the radiators 120A and 120B. Further, since the distance between the two feed points P31 and P33 is small, it is possible to minimize an area for placing traces of feed lines from a wireless communication circuit (not shown). In addition, any of the radiation conductors 31 to 36 may be bent at at least one position in order to reduce the size of the antenna apparatus. For example, the radiation conductors 31 and 32 may be bent at positions of dotted lines A1 to A4 on the radiation conductors 31 and 32.

According to the antenna apparatus of FIG. 30, the capacitor C31 and the capacitor between the radiation conductors 32 and 33 are disposed at closer positions to the ground conductor G1, than the position of the inductor L31, and the capacitor C32 and the capacitor between the radiation conductors 35 and 36 are disposed at closer positions to the ground conductor G1, than the position of the inductor L32. The positions of the capacitors and the inductors are not limited to those shown in FIG. 30. For example, an inductor may be disposed at closer positions to the ground conductor G1, than the positions of capacitors, or capacitors and an inductor may be provided along a looped radiation conductor and within a portion where the radiation conductor and the ground conductor G1 are close to each other.

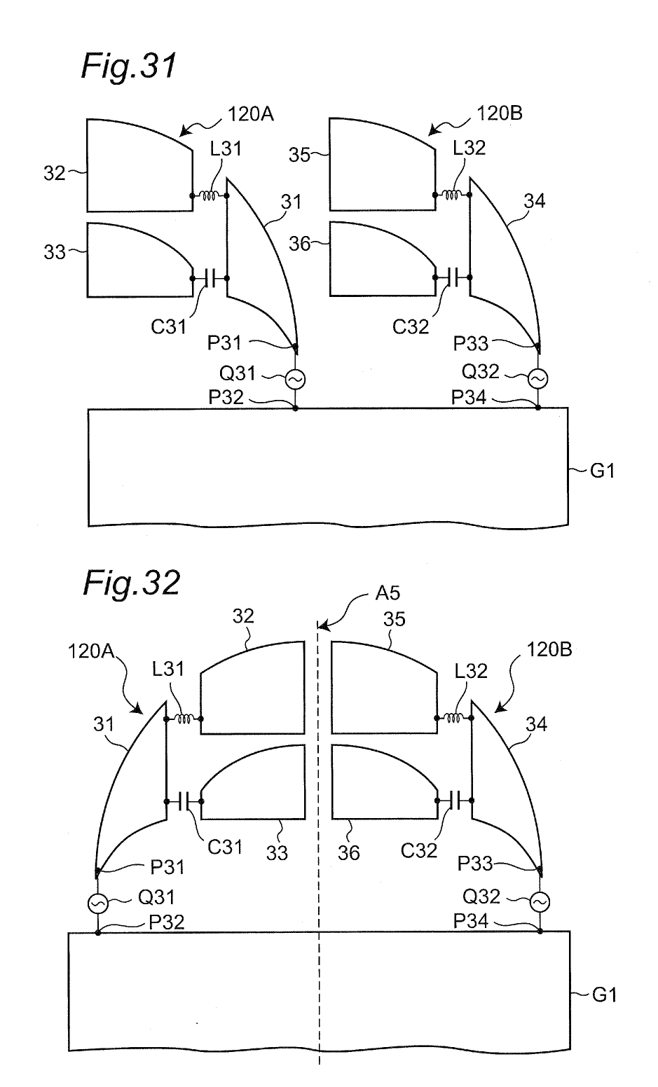

FIG. 31 is a schematic diagram showing an antenna apparatus according to a first modified embodiment of the third embodiment of the present invention. According to the antenna apparatus of this modified embodiment, radiators 120A and 120B are disposed in the same direction (i.e., asymmetrically), rather than being disposed symmetrically. The asymmetric disposition of the radiators 120A and 120B results in their asymmetric radiation patterns, thus providing the advantageous effect of a reduced correlation between signals transmitted or received through the radiators 120A and 120B. However, since a difference occurs between powers of transmitting signals and between powers of received signals, it is not possible to maximize the receiving performance for a MIMO communication scheme. Further, three or more radiators may be disposed in a manner similar to that of the antenna apparatus of this modified embodiment.

FIG. 32 is a schematic diagram showing an antenna apparatus according to a comparison example. According to the antenna apparatus of FIG. 32, radiation conductors 32, 33, 35, and 36 not having feed points are disposed close to one another. By separating feed points P31 and P33 from each other, it is possible to reduce the correlation between signals transmitted or received through radiators 120A and 120B. However, since the open ends of the respective radiators 120A and 120B (i.e., the edges of the radiation conductors 32, 33, 35, and 36) are opposed to each other, the electromagnetic coupling between the radiators 120A and 120B is large.

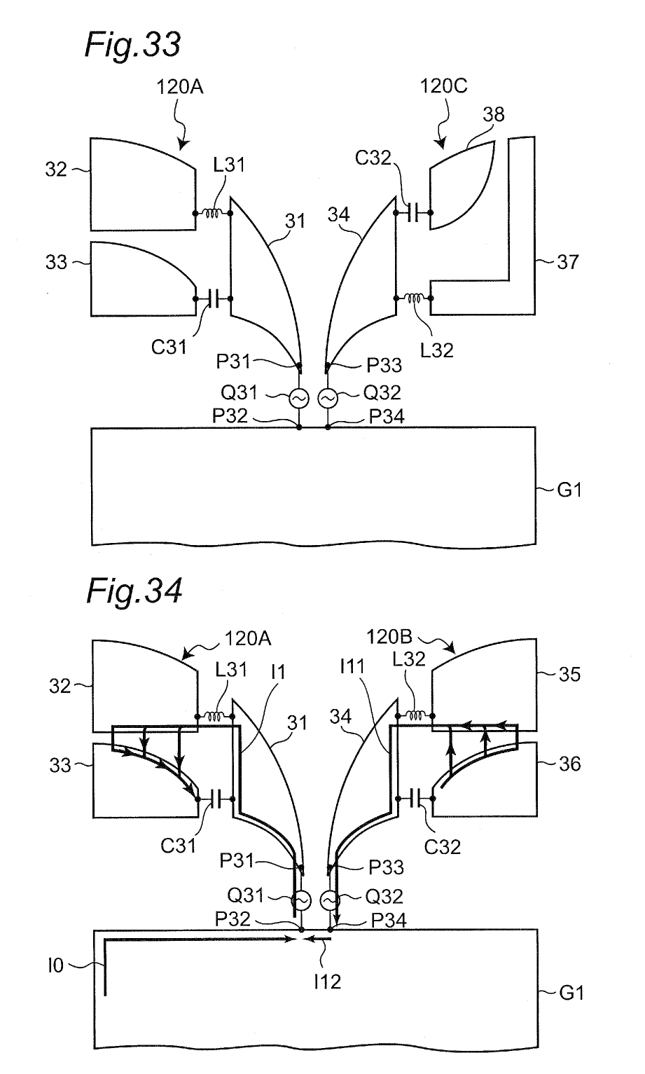

FIG. 33 is a schematic diagram showing an antenna apparatus according to a second modified embodiment of the third embodiment of the present invention. The antenna apparatus of this modified embodiment is configured in the similar manner as that of the radiator 120B of FIG. 30, except that the antenna apparatus includes radiators 120A and 120C, and in the radiator 120C, an inductor L32 is disposed at a closer position to a ground conductor G1, than the positions of a capacitor C32 and a capacitor between radiation conductors 35 and 36. The antenna apparatus of this modified embodiment is configured such that the positions of the capacitors and inductor of the radiator 120C are made asymmetric to the positions of capacitors and an inductor of the radiator 120A in order to reduce the electromagnetic coupling between the radiators 120A and 120C occurring when the antenna apparatus operates at the low-band resonance frequency f1.

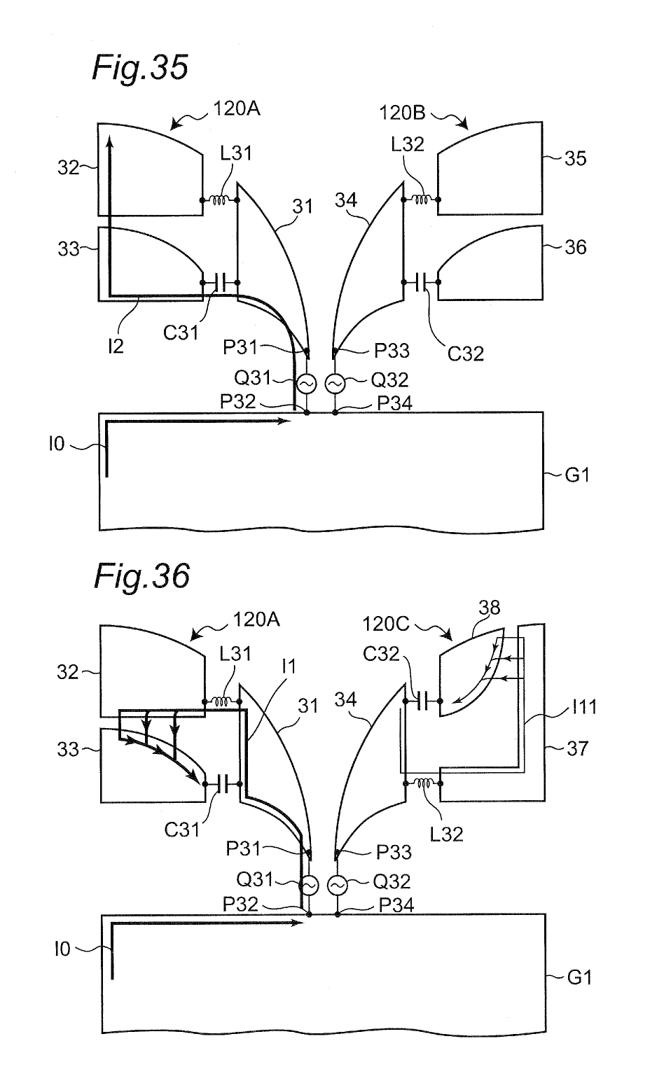

FIG. 34 is a diagram showing current paths for the case where the antenna apparatus of FIG. 30 operates at the low-band resonance frequency f1. Suppose that, for example, only one signal source Q31 operates when the antenna apparatus of FIG. 30 operates at the low-band resonance frequency f1. When the radiator 120A operates in a loop antenna mode by a current I1 inputted from the signal source Q31, a magnetic field produced by the radiator 120A induces a current I11 in the radiator 120B, the current I11 flowing in the same direction as the current I1, and flowing to the signal source Q32. A current I12 also flows from the connecting point P34 to the connecting point P32 on the ground conductor G1. Since the large current I11 flows, the large electromagnetic coupling between the radiators 120A and 120B occurs. FIG. 35 is a diagram showing a current path for the case where the antenna apparatus of FIG. 30 operates at the high-band resonance frequency f2. In the radiator 120A, a current I1 inputted from the signal source Q31 flows in a direction opposite to the radiator 120B. Thus, the electromagnetic coupling between the radiators 120A and 120B is small, and an induced current flowing through the radiator 120B and the signal source Q32 is also small.

According to the antenna apparatus of FIG. 33, the loops of radiation conductors of the radiators 120A and 120C are configured to be substantially symmetric with respect to a reference axis A5. When proceeding along the symmetric loops of the radiation conductors of the radiators 120A and 120C in corresponding directions starting from respective feed points (i.e., when proceeding counterclockwise in the radiator 120A and proceeding clockwise in the radiator 120C), the radiator 120A is configured such that a feed point P31, an inductor L31, a capacitor between radiation conductors 32 and 33, and a capacitor C31 are located in this order, and the radiator 120C is configured such that a feed point P33, the capacitor C32, the capacitor between the radiation conductors 35 and 36, and the inductor L32 are located in this order. As a result, in the antenna apparatus of FIG. 33, the radiator 120A is configured such that the capacitor C31 and the capacitor between the radiation conductors 32 and 33 are disposed at closer positions to the ground conductor G1, than the position of the inductor L31, and on the other hand, the radiator 120B is configured such that the inductor L32 is disposed at a closer position to the ground conductor G1, than the positions of the capacitor C32 and the capacitor between the radiation conductors 35 and 36. Since the capacitors and the inductors are asymmetrically arranged between the radiators 120A and 1200 as described above, the electromagnetic coupling between the radiators 120A and 120C is reduced.

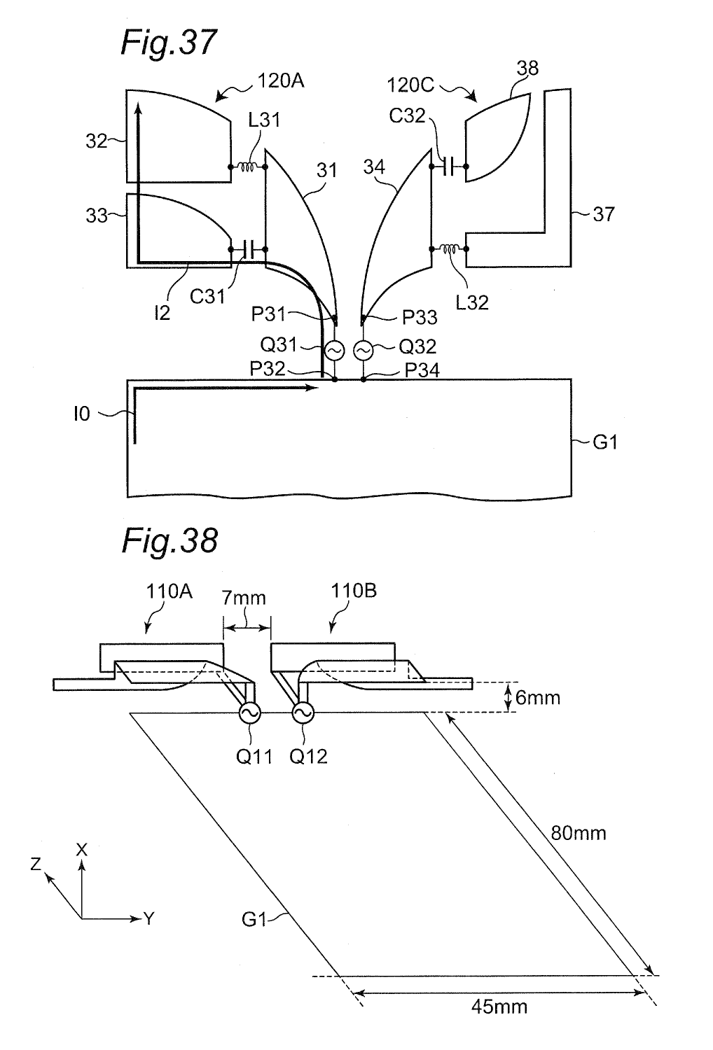

FIG. 36 is a diagram showing a current path for the case where the antenna apparatus of FIG. 33 operates at the low-band resonance frequency f1. As described above, by nature, a current having a low frequency component can pass through an inductor, but is difficult to pass through a capacitor. Therefore, even if the radiator 120A operates in a loop antenna mode by a current I1 inputted from a signal source Q31, a current I11 induced in the radiator 120C is small, and a current flowing from the radiator 120C to a signal source Q32 is also small. Thus, the electromagnetic coupling between the radiators 120A and 120C occurring when the antenna apparatus of FIG. 33 operates at the low-band resonance frequency f1 is small. FIG. 37 is a diagram showing a current path for the case where the antenna apparatus of FIG. 33 operates at the high-band resonance frequency f2. In this case, similar to the case of FIG. 35, the electromagnetic coupling between the radiators 120A and 120C is small.

According to the antenna apparatus of the present embodiment, it is possible to effectively achieve dual-band operation and reduce size of the antenna apparatus, by independently exciting the two radiators, and by using the two radiators to operate in one of a loop antenna mode and a monopole antenna mode according to an operating frequency. In addition, the antenna apparatus of the present embodiment can operate over a wide bandwidth at both low-band frequencies and high-band frequencies.

### Fourth Embodiment

FIG. 38 is a perspective view showing an antenna apparatus according to a fourth embodiment of the present invention. The antenna apparatus of FIG. 38 includes two radiators 110A and 110B configured according to the similar principle as that for the radiator 110 of FIG. 22, and the radiators 110A and 110B are independently excited by different signal sources Q11 and Q12.

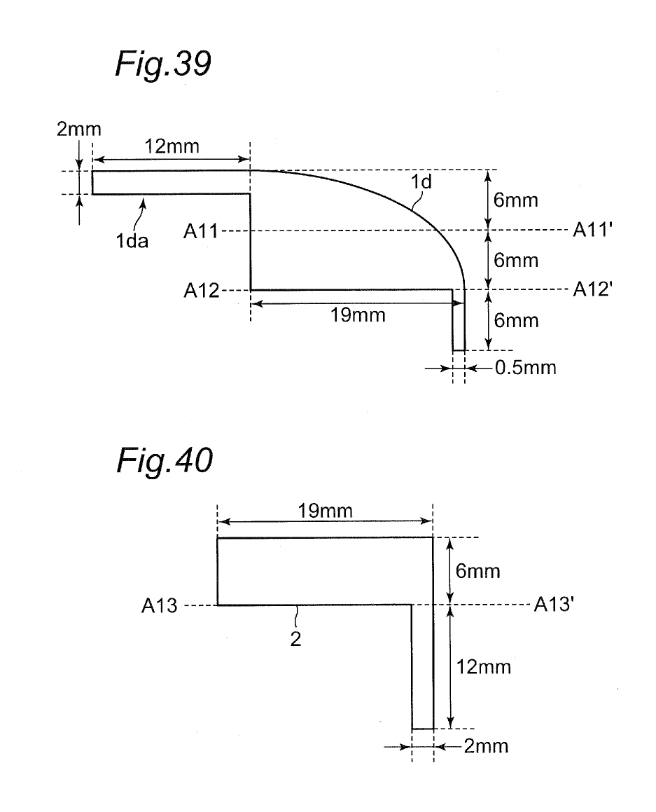

The radiator 110A of FIG. 38 is configured in the similar manner as that of the radiator 110 of FIG. 22. In FIG. 38, inductors L1 and L2 and a capacitor C2 of FIG. 22 are omitted for ease of illustration. In addition, in FIG. 38, a feed point P1, a connecting point P2, and a signal source Q1 of FIG. 22 are collectively represented by the reference sign of the signal source Q11. FIG. 39 is an unfolded view of a radiation conductor 1d of the radiator 110A of FIG. 38, and FIG. 40 is an unfolded view of a radiation conductor 2 of the radiator 110A of FIG. 38. In order to reduce the size of the radiator 110A, the radiation conductor 1d is bent at right angles at the positions of line A11-A11′ and line A12-A12′ of FIG. 39, and the radiation conductor 2 is bent at a right angle at the position of line A13-A13′ of FIG. 40. A chip capacitor C2 and a chip inductor L2 are connected to a lower end of the radiation conductor 1d of FIG. 39, a chip inductor L1 is connected to a lower end of the radiation conductor 2 of FIG. 40, and a feed point P1 is provided between the inductors L1 and L2. The radiator 110B of FIG. 38 is configured in the similar manner as that of the radiator 110A and symmetrically to the radiator 110A. The signal sources Q31 and Q32 generate, for example, radio-frequency signals as transmitting signals of a MIMO communication scheme. The signal sources Q31 and Q32 generate radio-frequency signals with the same low-band resonance frequency f1, radio-frequency signals with the same mid-band resonance frequency f3, and radio-frequency signals with the same high-band resonance frequency f2.

Simulations were performed on the antenna apparatus of the present embodiment. Using software “CST Microwave Studio”, a transient analysis was performed. A convergence was determined using a threshold value of a point at which the reflection energy at the feed point is −50 dB or less with respect to input energy. A portion where a current strongly flows was finely modeled using the sub-mesh method.

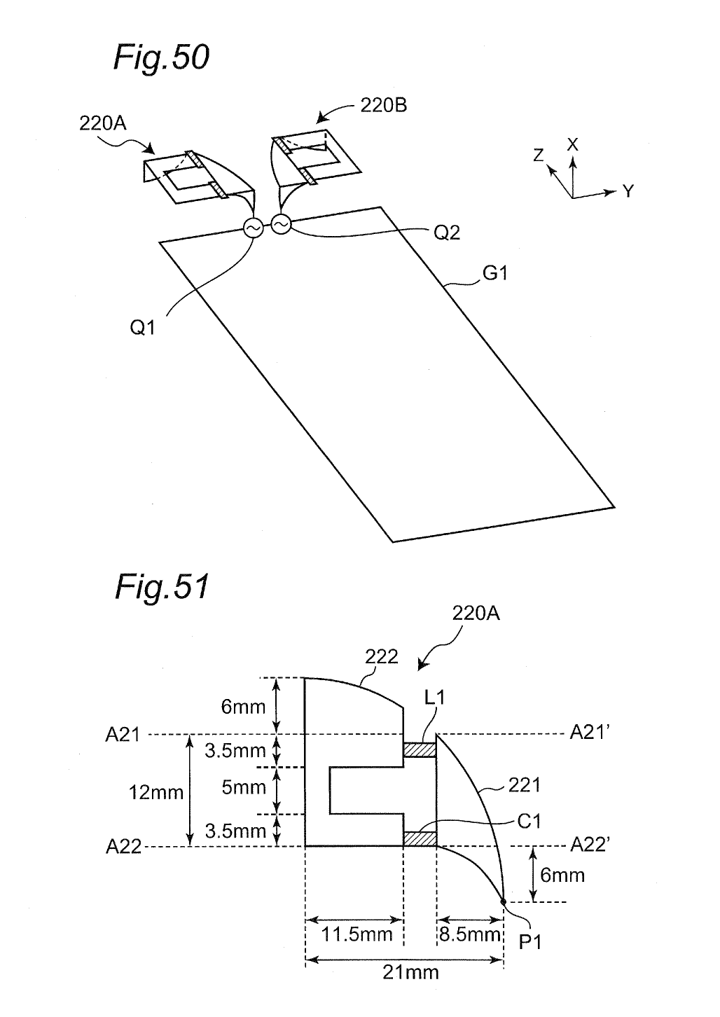

Firstly, with reference to FIGS. 50 to 52, the simulation results of an antenna apparatus of a comparison example are shown. FIG. 50 is a perspective view showing an antenna apparatus according to a comparison example of the fourth embodiment of the present invention, and FIG. 51 is an unfolded view showing a detailed configuration of a radiator 220A of the antenna apparatus of FIG. 50. The antenna apparatus of FIG. 50 includes two radiators 220A and 2208 corresponding to a radiator 200 of FIG. 5, i.e., radiators each having a discrete capacitor C1, instead of a capacitor formed by a capacitance between radiation conductors. According to the radiator 220A of FIG. 51, a loop surrounding a central hollow portion is formed by radiation conductors 221 and 222, the capacitor C1, and an inductor L1. The capacitor C1 having a capacitance of 2 pF and the'inductor L1 having an inductance of 1.5 nH were used. In order to reduce the size of the radiator 210A, the radiation conductor 221 is bent at a right angle at the position of line A22-A22′ of FIG. 51, and the radiation conductor 222 is bent at a right angle at the position of line A21-A21′ of FIG. 51. In FIG. 50, for ease of illustration, feed points on the radiators 220A and 220B, connecting points on a ground conductor G1, and signal sources Q1 and Q2 are collectively represented by the reference signs of the signal sources Q1 and Q2, respectively. The radiator 220B is configured in the similar manner as that of the radiator 220A and symmetrically to the radiator 220A.

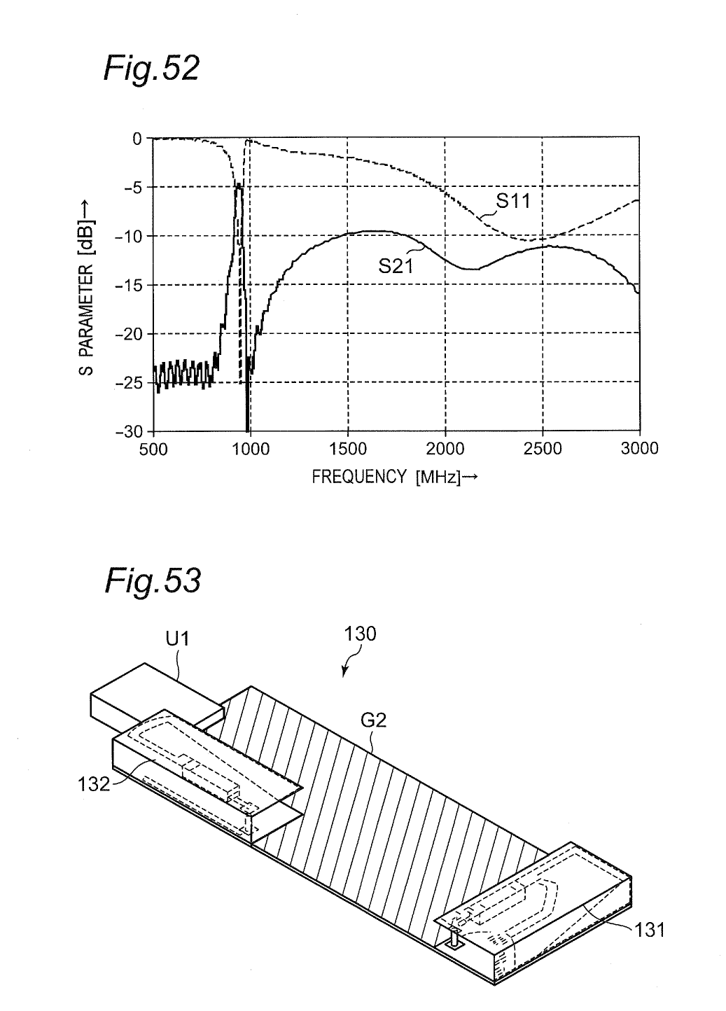

FIG. 52 is a graph showing frequency characteristics of S parameters S11 and S21 representing the reflection coefficient and transmission coefficient of the antenna apparatus of FIG. 50. It can be seen that S11 decreased at both a low-band resonance frequency f1=870 MHz and a high-band resonance frequency f2=2400 MHz, and thus, dual-band operation is achieved. However, S11 is high at a mid-band resonance frequency f3=1500 MHz.

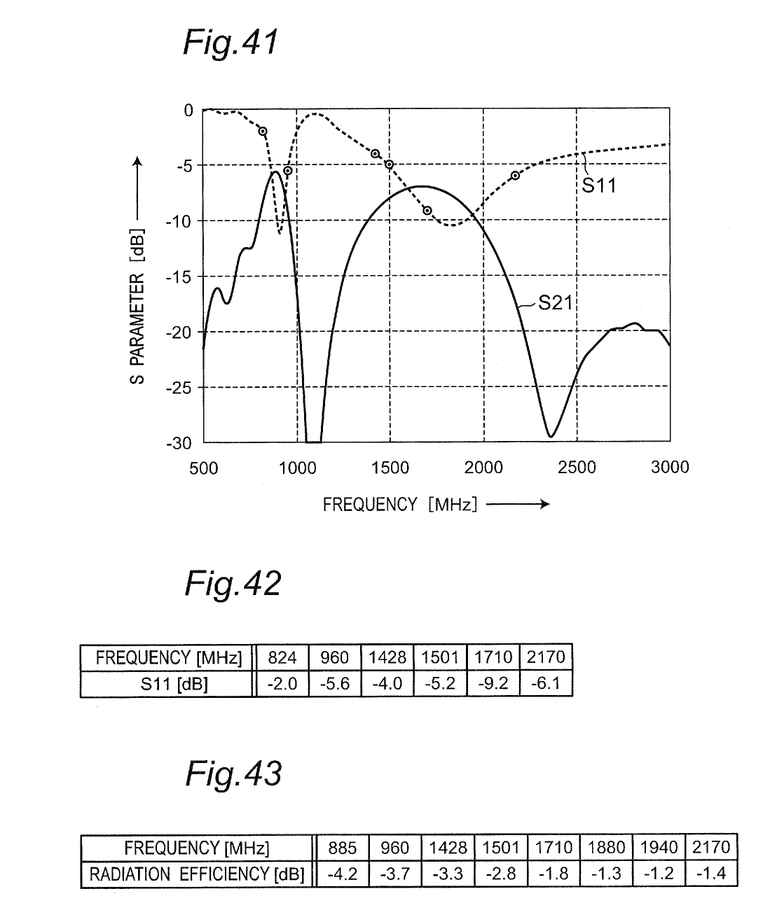

FIG. 41 is a graph showing frequency characteristics of S parameters S11 and S21 representing the reflection coefficient and transmission coefficient of the antenna apparatus of FIG. 38. In the simulation, an inductor L1 having an inductance of 28 nH, an inductor L2 having an inductance of 3 nH, and a capacitor C2 having a capacitance of 4 pF were used, and the dimensions of the inductors L1 and L2 and the capacitor C2 were ignored. According to FIG. 41, S11 decreased at a low-band resonance frequency f1=900 MHz and a high-band resonance frequency f2=1800 MHz, and further, S11 decreased at a mid-band resonance frequency f3=1500 MHz compared to the case of FIG. 52. FIG. 42 is a table showing frequency characteristics of the S parameter S11 representing the reflection coefficient of the antenna apparatus of FIG. 38. FIG. 42 shows several values on the graph of FIG. 41. FIG. 43 is a table showing a radiation efficiency of the antenna apparatus of FIG. 38. The radiation efficiency represents “output power/input power”. According to FIG. 43, it can be seen that a MIMO antenna apparatus having high radiation efficiency was achieved at all of the low-band resonance frequency f1, the mid-band resonance frequency f3, and the high-band resonance frequency f2.

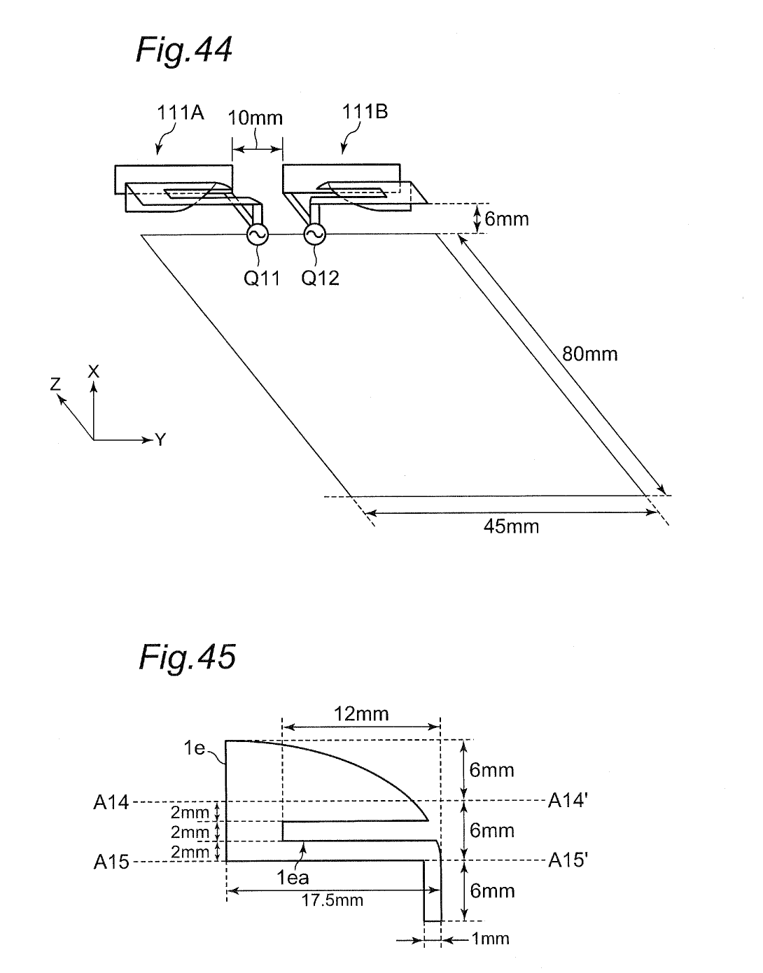

FIG. 44 is a perspective view showing an antenna apparatus according to a modified embodiment of the fourth embodiment of the present invention. The antenna apparatus of FIG. 44 includes two radiators 111A and 111B configured according to the similar principle as that for a radiator 111 of FIG. 26, and the radiators 111A and 111B are independently excited by different signal sources Q11 and Q12.

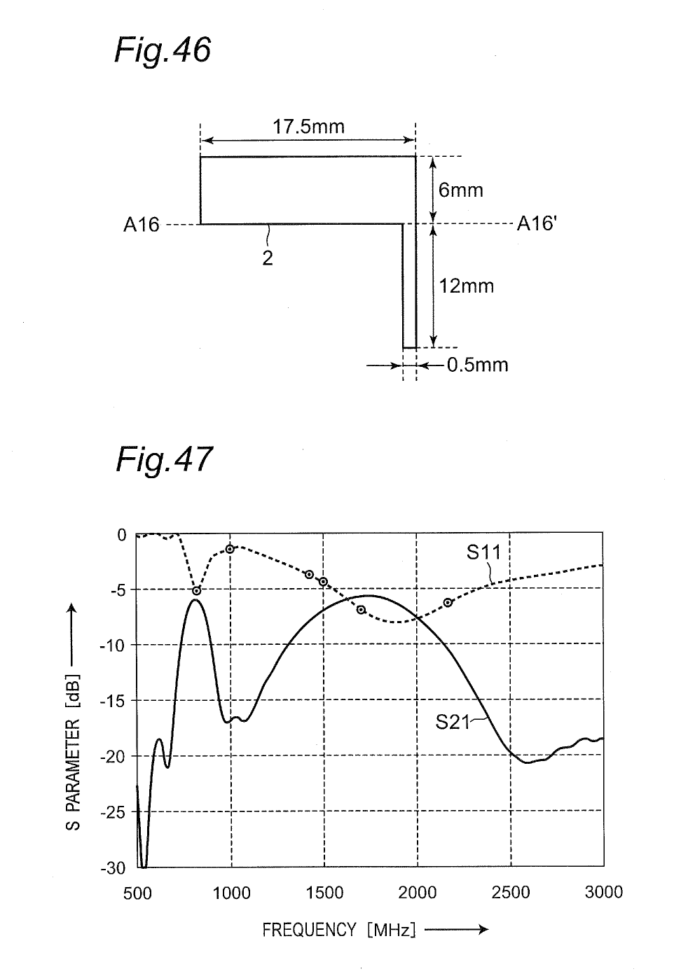

The radiator 111A of FIG. 44 is configured in the similar manner as that of the radiator 111 of FIG. 26. In FIG. 44, inductors L1 and L3 and a capacitor C2 of FIG. 26 are omitted for ease of illustration. In addition, in FIG. 44, a feed point P1, a connecting point P2, and a signal source Q1 of FIG. 26 are collectively represented by the reference sign of the signal source Q11. FIG. 45 is an unfolded view of a radiation conductor 1e of the radiator 111A of FIG. 44, and FIG. 46 is an unfolded view of a radiation conductor 2 of the radiator 111A of FIG. 44. In order to reduce the size of the radiator 111A, the radiation conductor 1e is bent at right angles at the positions of line A14-A14′ and line A15-A15′ of FIG. 39, and the radiation conductor 2 is bent at a right angle at the position of line A16-A16′ of FIG. 40. A chip capacitor C2 is connected to a lower end of the radiation conductor 1e of FIG. 45, a chip inductor L1 is connected to a lower end of the radiation conductor 2 of FIG. 46, and a feed point P1 is provided between the inductor L1 and the capacitor C2. The feed point P1 is further connected to a ground conductor G1 through an inductor L3. The radiator 111B of FIG. 44 is configured in the similar manner as that of the radiator 111A and symmetrically to the radiator 111A. Since the antenna apparatus of FIG. 44 does not have extension conductors protruding from radiators as that of the antenna apparatus of FIG. 38, the size of the antenna apparatus can be reduced.

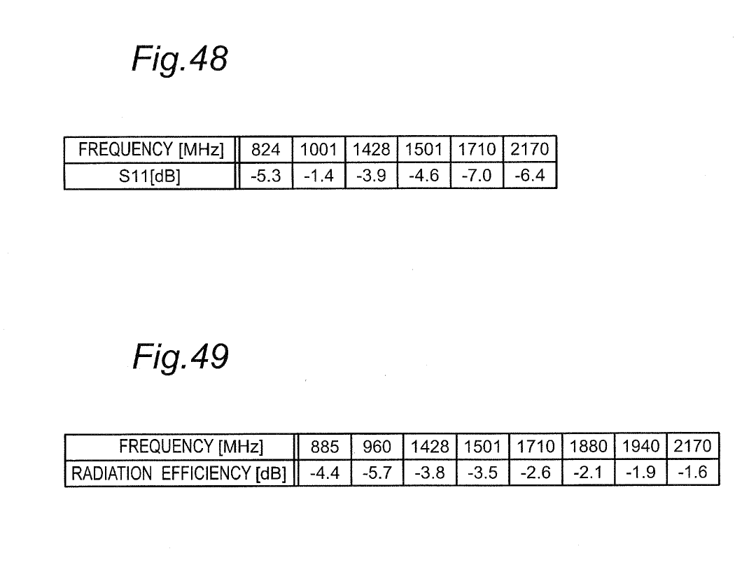

FIG. 47 is a graph showing frequency characteristics of S parameters S11 and S21 representing the reflection coefficient and transmission coefficient of the antenna apparatus of FIG. 44. In the simulation, the inductor L1 having an inductance of 39 nH, the inductor L3 having an inductance of 3.9 nH, and the capacitor C2 having a capacitance of 2.5 pF were used, and the dimensions of the inductors L1 and L3 and the capacitor C2 were ignored. According to FIG. 47, S21 was slightly high at a low-band resonance frequency f1=800 MHz and a high-band resonance frequency f2=1900 MHz (about −6 dB), but S11 was low, and S11 was further small at a mid-band resonance frequency f3=1500 MHz compared to the case of FIG. 52. FIG. 48 is a table showing frequency characteristics of the S parameter S11 representing the reflection coefficient of the antenna apparatus of FIG. 44. FIG. 48 shows several values on the graph of FIG. 47. FIG. 49 is a table showing a radiation efficiency of the antenna apparatus of FIG. 44. According to FIG. 49, it can be seen that a MIMO antenna apparatus having high radiation efficiency was achieved at all of the low-band resonance frequency f1, the mid-band resonance frequency f3, and the high-band resonance frequency f2.

### Fifth Embodiment

FIG. 53 is a perspective view showing an antenna apparatus according to a fifth embodiment of the present invention. An antenna apparatus 130 of FIG. 53 is configured to include two radiators 131 and 132 provided on a ground conductor G2 with a certain distance therebetween, and to be connected to a USB socket (not shown) through a USB plug U1.

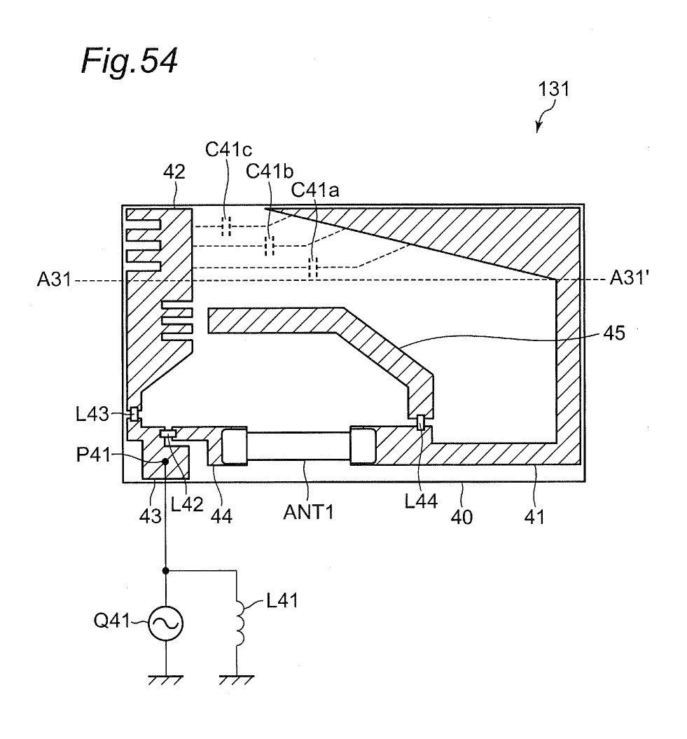

FIG. 54 is an unfolded view showing a circuit of the radiator 131 of FIG. 53. Radiation conductors 41, 42, 43, 44, and 45 are formed on a dielectric board 40. A feed point P41 is provided on the radiation conductor 43, and the feed point P41 is connected to a signal source Q41 and an inductor L41. An inductor L42 is provided between the radiation conductors 43 and 44, an inductor L43 is provided between the radiation conductors 43 and 42, and an inductor L44 is provided between the radiation conductors 41 and 45. A chip antenna ANT1 is provided between the radiation conductors 41 and 44. The radiator 131 further has a capacitor formed by a capacitance between the radiation conductors 41 and 42. The capacitance between the radiation conductors 41 and 42 varies depending on the positions on the radiation conductors 41 and 42 within a portion where the radiation conductors 41 and 42 are close to each other. In FIGS. 54 and 56, the capacitance variable depending on the positions is shown as virtual capacitors C41a to C41c for the purpose of explanation. The radiator 131 is bent at a right angle at the position of line A31-A31′ of FIG. 54. When the radiator 131 operates at the low-band resonance frequency f1, a current flows from the feed point P41 to the radiation conductor 41, and when the radiator 131 operates at the high-band resonance frequency f2, a current flows from the feed point P41 to the radiation conductor 42.

The chip antenna ANT1 is disclosed in, for example, Patent Literatures 4 to 6. The chip antenna ANT1 is provided with: a bar dielectric member; a radiation element helically formed on a surface along a longitudinal direction of the dielectric member; and first and second electrodes connected to the radiation element at both ends of the dielectric member, respectively. Patent Literature 5 discloses that a wider bandwidth can be achieved by providing a top hat conductor at a tip of a chip antenna. By further combining an antenna apparatus of FIG. 1, etc. with a chip antenna ANT1, a wider band can be achieved in addition to the advantageous effect provided by the antenna apparatus of FIG. 1, etc.

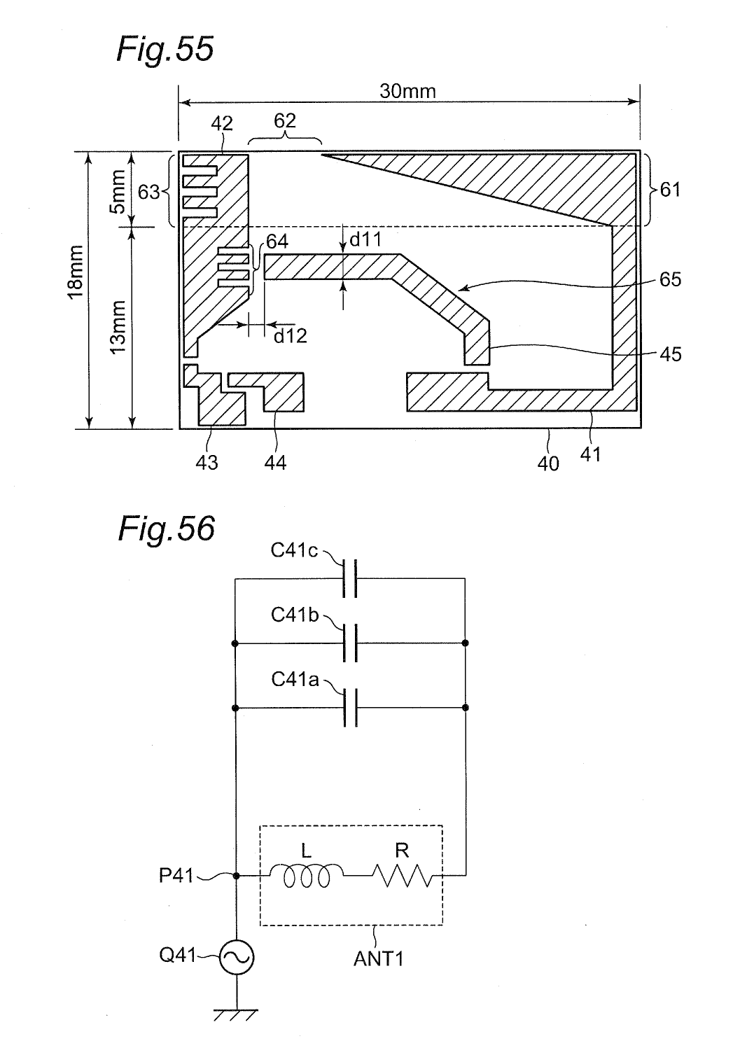

FIG. 55 is an unfolded view showing a detailed configuration of the radiation conductors 41, 42, 43, 44, and 45 of the radiator 131 of FIG. 53. A tip 61 of the radiation conductor 41 has a tapered shape, spreading toward the top in FIG. 55. By using the radiation conductor 41 having such a shape, there is an advantageous effect that it is possible to adjust the amount of electromagnetic coupling with the radiation conductor 42 in a stepwise manner, to achieve a wide bandwidth. In addition, in the capacitor between the radiation conductors 41 and 42, a gap 62 with a certain length is provided between the radiation conductors 41 and 42. Reducing the distance between the radiation conductors 41 and 42 results in stronger coupling, and results in a narrower bandwidth of VSWR particularly for the case where the antenna apparatus operates at the low-band resonance frequency f1. A wider bandwidth of VSWR is achieved by providing a moderate gap 62 between the radiation conductors 41 and 42. In addition, comb structures 63 and 64 are provided at the perimeter of the radiation conductor 42 through which a current flows when the radiator 131 operates at the high-band resonance frequency f2. By providing the comb structures 63 and 64, there is an advantageous effect that it is possible to increase the length of the perimeter of the radiation conductor 42 with a limited size, thus decreasing the high-band resonance frequency f2. In addition, by providing the radiation conductor 45, it is possible to finely adjust the amount of current flowing through the comb structure 64 of the radiation conductor 42, and thus, finely adjust the resonance bandwidth including the high-band resonance frequency f2. In addition, the radiation conductor 45 is provided with a chamfered bend so as to separate from the radiation conductor 41 to reduce the coupling with the radiation conductor 41. By providing the bend to the radiation conductor 45, it is possible to avoid degradation in bandwidth and efficiency. In addition, a width d11 of the radiation conductor 45 is determined so as to reduce the coupling with the radiation conductor 41 and so as to optimize the resonance bandwidth of the radiation conductor 45 itself. The width d11 of the radiation conductor 45 is selected from the range of, for example, 0.8 mm to 3.2 mm, and is preferably set to 1.6 mm. In addition, a distance d12 between the radiation conductors 42 and 45 is determined so as to finely adjust characteristics for the case where the radiator 131 operates at the high-band resonance frequency f2, and is selected from the range of, for example, 0.5 mm to 1 mm.

FIG. 56 is a diagram showing an equivalent circuit of the radiator 131 of FIG. 53. The radiator 131 can operate in the similar manner as that of an antenna apparatus of FIG. 1. The chip antenna ANT1 has an inductance L, and additionally, has a property as an antenna, including a radiation resistance R. Hence, there are advantageous effects that it is possible to achieve high radiation efficiency, while the overall dimensions of the radiator 131 are dramatically reduced. In addition, due to the effect of reduction in electrical length by the chip antenna ANT1, it is possible to increase the tapered area of the radiation conductor 41, thus increasing design flexibility including the tapered portion, and more easily achieving a wider bandwidth.

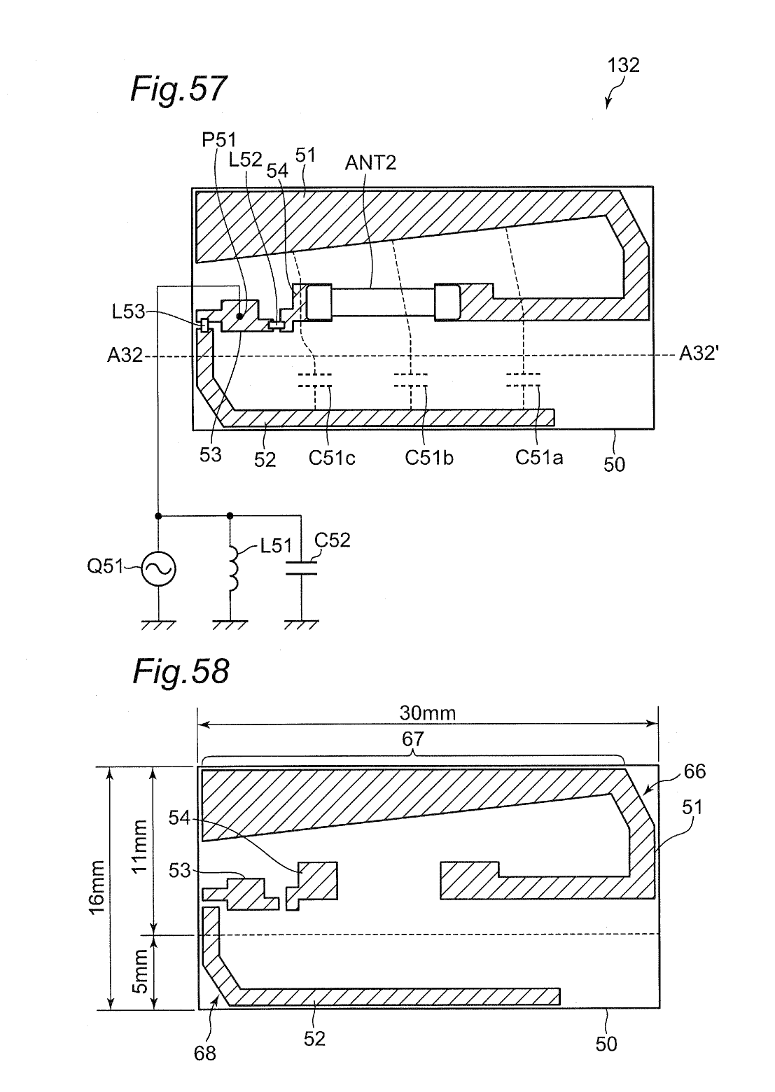

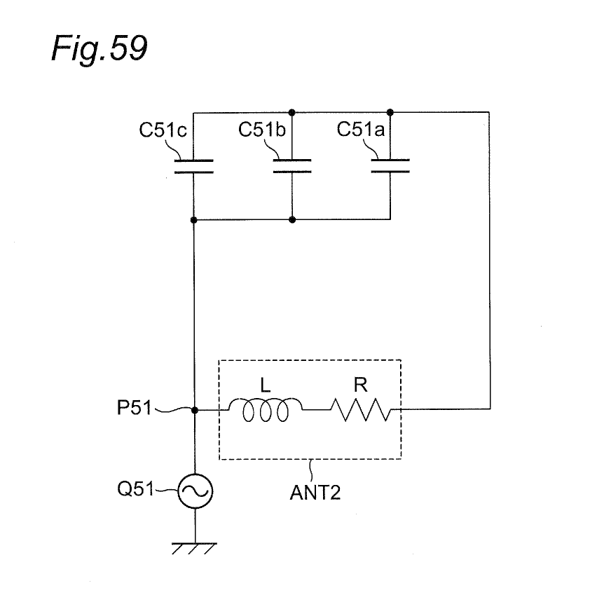

FIG. 57 is an unfolded view showing a circuit of the radiator 132 of FIG. 53. Radiation conductors 51, 52, 53, and 54 are formed on a dielectric board 50. A feed point P51 is provided on the radiation conductor 53, and the feed point P51 is connected to a signal source Q51, an inductor L51, and a capacitor C52. An inductor L52 is provided between the radiation conductors 53 and 54, and an inductor L53 is provided between the radiation conductors 53 and 52. A chip antenna ANT2 is provided between the radiation conductors 51 and 54. The chip antenna ANT2 is configured in the similar manner as that of the chip antenna ANT1 of FIG. 54. The radiator 132 further has a capacitor formed by a capacitance between the radiation conductors 51 and 52. The capacitance between the radiation conductors 51 and 52 varies depending on the positions on the radiation conductors 51 and 52 within a portion where the radiation conductors 51 and 52 are close to each other. In FIGS. 57 and 59, the capacitance variable depending on the positions is shown as virtual capacitors C51a to C51c for the purpose of explanation. The radiator 132 is bent at a right angle at the position of line A32-A32′ of FIG. 55. When the radiator 132 operates at the low-band resonance frequency f1, a current flows from the feed point P51 to the radiation conductor 51, and when the radiator 132 operates at the high-band resonance frequency f2, a current flows from the feed point P51 to the radiation conductor 52.

FIG. 58 is an unfolded view showing a detailed configuration of the radiation conductors 51, 52, 53, and 54 of the radiator 132 of FIG. 53. A tip 67 of the radiation conductor 51 has a tapered shape, spreading toward the left in FIG. 58. By using the radiation conductor 51 having such a shape, there is an advantageous effect that it is possible to adjust the amount of electromagnetic coupling with the radiation conductor 52 in a stepwise manner, to achieve a wide bandwidth. In addition, portions close to the ground conductor G2 of FIG. 53, i.e., a corner portion 66 of the radiation conductor 51 and a corner portion 68 of the radiation conductor 52, are provided with chamfered bends so as to separate from the ground conductor G2 to reduce the coupling with the ground conductor G2. By separating the radiation conductors 51 and 52 from the ground conductor G2, a reduction in radiation efficiency is prevented. In addition, in the radiator 132 bent in two parts at the position of line A32-A32′ of FIG. 57, the radiation conductor 51 through which a current flows when the radiator 132 operates at the low-band resonance frequency f1 is provided on a larger one of the two bends, and the radiation conductor 52 through which a current flows when the radiator 132 operates at the high-band resonance frequency f2 is provided on a smaller one of the two bends. By disposing the radiation conductors 51 and 52 as described above, it is possible to maximize the bandwidth for low-band frequencies.

FIG. 59 is a diagram showing an equivalent circuit of the radiator 132 of FIG. 53. The radiator 132 can operate in the similar manner as that of an antenna apparatus of FIG. 1.

Next, the simulation results of the radiators 131 and 132 of FIG. 53 are shown. The radiator 131, including the inductor L41 having an inductance of 27 nH, the inductor L42 having an inductance of 1.0 nH, the inductor L43 having an inductance of 3.3 nH, and the inductor L44 having an inductance of 6.8 nH, was used. As the chip antenna ANT1, a chip antenna “EBMGHAG” available from by Panasonic Corporation was used. The dimensions of the chip antenna ANT1 ware 2.2×2.2×10 mm. The impedance of the radiator 131 seen from the signal source Q41 was 50Ω. The radiator 132, including the capacitor C52 having a capacitance of 0.5 pF, the inductor L51 having an inductance of 12 nH, the inductor L52 having an inductance of 1.0 nH, and the inductor L53 having an inductance of 1.0 nH, was used. As the chip antenna ANT2, a chip antenna “EBMGHAG” available from Panasonic Corporation was used. The impedance of the radiator 132 seen from the signal source Q51 was 50Ω.

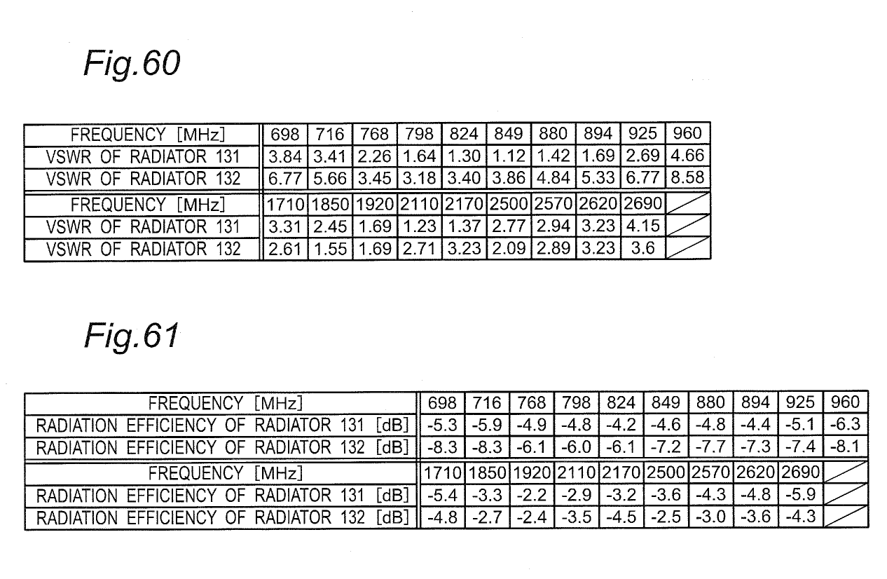

FIG. 60 is a table showing VSWRs of the radiators 131 and 132 of FIG. 53. FIG. 61 is a table showing radiation efficiencies of the radiators 131 and 132 of FIG. 53. It is possible to effectively achieve dual-band operation and reduce size of the antenna apparatus 103, by using both the radiators 131 and 132 to operate in one of a loop antenna mode and a monopole antenna mode according to an operating frequency. In addition, the antenna apparatus 130 can operate over a wide bandwidth at both low-band frequencies and high-band frequencies.

Since the antenna apparatus 130 includes the two radiators 131 and 132, the antenna apparatus 130 can operate as a MIMO antenna apparatus.

### Sixth Embodiment

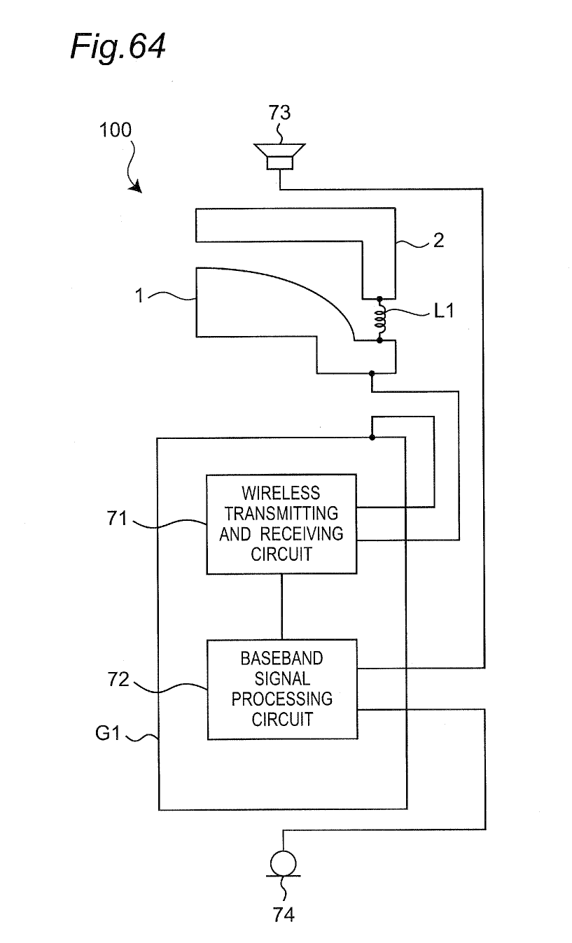

FIG. 64 is a block diagram showing a configuration of a wireless communication apparatus according to a sixth embodiment of the present invention, the wireless communication apparatus being provided with an antenna apparatus of FIG. 1. A wireless communication apparatus according to an embodiment of the present invention may be configured as, for example, a mobile phone as shown in FIG. 64. The wireless communication apparatus of FIG. 64 is provided with an antenna apparatus of FIG. 1, a wireless transmitting and receiving circuit 71, a baseband signal processing circuit 72 connected to the wireless transmitting and receiving circuit 71, and a speaker 73 and a microphone 74 which are connected to the baseband signal processing circuit 72. A feed point P1 of a radiator 100 and a connecting point P2 of a ground conductor G1 of the antenna apparatus are connected to the wireless transmitting and receiving circuit 71, instead of the signal source Q1 of FIG. 1. When implementing a wireless broadband router apparatus, a M2M (Machine-to-Machine) high-speed wireless communication apparatus, or the like as a wireless communication apparatus, it is not necessary to have a speaker, a microphone, etc., and alternatively, an LED (Light-Emitting Diode), etc., may be used to check the communication status of the wireless communication apparatus. Wireless communication apparatuses to which antenna apparatuses of FIG. 1, etc., are applicable are not limited to those exemplified above.

According to the wireless communication apparatus of the present embodiment, it is possible to effectively achieve dual-band operation and reduce size of the wireless communication apparatus, by using the radiator 100 to operate in one of a loop antenna mode and a monopole antenna mode according to an operating frequency. In addition, the wireless communication apparatus of FIG. 64 can operate over a wide bandwidth at both low-band frequencies and high-band frequencies.

The embodiments and modified embodiments described above may be combined with each other.

### INDUSTRIAL APPLICABILITY

As described above, antenna apparatuses of the present invention are operable in multiple bands, while having a simple and small configuration. In addition, when including a plurality of radiators, the antenna apparatuses of the present invention have low coupling between antenna elements, and is operable to simultaneously transmit or receive a plurality of radio signals.

The antenna apparatuses of the present invention and wireless communication apparatuses using the antenna apparatuses can be implemented as, for example, mobile phones, wireless LAN apparatuses, PDAs, etc. The antenna apparatuses can be mounted on, for example, wireless communication apparatuses for performing MIMO communication. In addition to MIMO, the antenna apparatuses can also be mounted on (multi-application) array antenna apparatuses capable of simultaneously performing communications for a plurality of applications, such as adaptive array antennas, maximal-ratio combining diversity antennas, and phased-array antennas.

### REFERENCE SIGNS LIST

1, 1a to 1f, 2, 2a, 3, 11, 12, 21, 22, 31 to 38, 41 to 45, 51 to 54, 201, 202, 211 to 213, 221, and 222: RADIATION CONDUCTOR,
1da: EXTENSION CONDUCTOR,
1ea: SLIT,
40, 50, and B1: DIELECTRIC BOARD,
71: WIRELESS TRANSMITTING AND RECEIVING CIRCUIT,
72: BASEBAND SIGNAL PROCESSING CIRCUIT,
73: SPEAKER,
74: MICROPHONE,
100 to 111, 100A to 100D, 110A, 110B, 111A, 111B, 120A to 120C, 131, 132, 200, 210, 220A, and 220B: RADIATOR,
130: ANTENNA APPARATUS,
ANT1 and ANT2: CHIP ANTENNA,
C1a, C1b, and C1c: VIRTUAL CAPACITOR,
C1, C2, C31, C32, and C52: CAPACITOR,
D1 to D3: DIELECTRIC,
G1 and G2: GROUND CONDUCTOR,
L1 to L3, L1a, L1b, L11, L21, L31, L32, L41 to L44, and L51 to L53: INDUCTOR,
M1: MATCHING CIRCUIT,
P1, P11, P21, P31, P33, P41, and P51: FEED POINT,
P2, P32, and P34: CONNECTING POINT,
Q1, Q2, Q11, Q12, Q21, Q31, Q32, Q41, and Q51: SIGNAL SOURCE,
S1: STRIP CONDUCTOR, and
U1: USB PLUG.

1. An antenna apparatus comprising at least one radiator,
wherein each of the radiators comprises:
a looped radiation conductor;
at least one capacitor inserted at a position along a loop of the radiation conductor;
at least one inductor inserted at a position along the loop of the radiation conductor, the position being different from the position of the capacitor; and
a feed point provided on the radiation conductor,
wherein the radiation conductor includes at least a first radiation conductor and a second radiation conductor,
wherein a first capacitor of the at least one capacitor is formed by a capacitance between the first and second radiation conductors, and the capacitance between the first and second radiation conductors varies depending on positions on the first and second radiation conductors within a portion where the first and second radiation conductors are close to each other, and
wherein each of the radiators is configured to:
resonate along a portion of the radiator at a first frequency, the portion including the inductor and the capacitor and being along the loop of the radiation conductor; and
resonate along a portion of the radiator at a second frequency higher than the first frequency, the portion including a section along the loop of the radiation conductor, the section including at least one of the at least one capacitor, not including the inductor, and extending between the feed point and the inductor.

2. The antenna apparatus as claimed in claim 1,
wherein the first capacitor of each of the radiators is configured such that within a portion where the first and second radiation conductors are close to each other and overlap each other, at least one of the first and second radiation conductors has a tapered shape, and areas of sub-portions of the portion vary depending on positions on the first and second radiation conductors.

3. The antenna apparatus as claimed in claim 1,
wherein the first capacitor of each of the radiators is configured such that a distance between the first and second radiation conductors varies depending on positions on the first and second radiation conductors.

4. The antenna apparatus as claimed in claim 1,
wherein the first capacitor of each of the radiators is configured such that a dielectric is provided between the first and second radiation conductors, and a dielectric constant of the dielectric varies depending on positions on the first and second radiation conductors.

5. The antenna apparatus as claimed in claim 1,
wherein the first capacitor of each of the radiators is configured such that at least one of the first and second radiation conductors has a tapered shape.

6. The antenna apparatus as claimed in claim 1, further comprising a matching circuit.

7. The antenna apparatus as claimed in claim 1,
wherein each of the radiators further comprises a second capacitor inserted at a closer position to the feed point along the loop of the radiation conductor, than the position of the first capacitor, and a capacitance of the second capacitor is larger than the capacitance of the first capacitor.

8. The antenna apparatus as claimed in claim 7,
wherein each of the radiators further comprises an extension conductor connected to an outer edge of the loop of the radiation conductor, between the first and second capacitors, and
wherein each of the radiators is configured to:
resonate along a portion of the radiator at the first frequency, the portion including the inductor and the first and second capacitors and being along the loop of the radiation conductor;
resonate along a portion of the radiator at the second frequency, the portion including a section along the loop of the radiation conductor, the section including the second capacitor, not including the inductor, and extending between the feed point and the first capacitor; and
resonate along a portion of the radiator at a third frequency between the first and second frequencies, the portion including a section along the loop of the radiation conductor and including the extension conductor, the section including the second capacitor, not including the inductor, and extending between the feed point and the first capacitor.

9. The antenna apparatus as claimed in claim 7,
wherein each of the radiators further comprises a slit provided at an inner edge of the loop of the radiation conductor, between the first and second capacitors, and
wherein each of the radiators is configured to:
resonate along a portion of the radiator at the first frequency, the portion including the inductor and the first and second capacitors, including the slit, and being along the loop of the radiation conductor;
resonate along a portion of the radiator at the second frequency, the portion including a section along the loop of the radiation conductor, the section including the second capacitor, not including the inductor, and extending between the feed point and the first capacitor; and
resonate along a portion of the radiator at a third frequency between the first and second frequencies, the portion including a section along the loop of the radiation conductor and including the slit, the section including the second capacitor, not including the inductor, and extending between the feed point and the first capacitor.

10. The antenna apparatus as claimed in claim 1,
wherein the radiation conductor is bent at at least one position.

11. The antenna apparatus as claimed in claim 1,
wherein the at least one inductor includes a chip antenna element,
wherein the chip antenna element comprises:
a bar dielectric member;
a radiation element helically formed on a surface along a longitudinal direction of the dielectric member; and
first and second electrodes connected to the radiation element at both ends of the dielectric member, respectively.

12. The antenna apparatus as claimed in claim 1,
wherein the at least one inductor includes an inductor made of a strip conductor.

13. The antenna apparatus as claimed in claim 1,
wherein the at least one inductor includes an inductor made of a meander conductor.

14. The antenna apparatus as claimed in claim 1, further comprising a ground conductor.

15. The antenna apparatus as claimed in claim 14, comprising:
a printed circuit board comprising the ground conductor, and a feed line connected to the feed point,
wherein the radiator is formed on the printed circuit board.

16. The antenna apparatus as claimed in claim 1,
wherein the antenna apparatus is a dipole antenna including at least a pair of radiators.

17. The antenna apparatus as claimed in claim 1, comprising a plurality of radiators, the plurality of radiators having different first frequencies and different second frequencies, respectively.

18. The antenna apparatus as claimed in claim 1, comprising a plurality of radiators connected to different signal sources.

19. The antenna apparatus as claimed in claim 18, comprising a first radiator and a second radiator that have radiation conductors formed symmetrically with respect to a reference axis,
wherein feed points of the first and second radiators are provided at positions symmetric with respect to the reference axis, and
wherein the radiation conductors of the first and second radiators are shaped such that a distance between the first and second radiators gradually increases as a distance from the feed points of the first and second radiators along the reference axis increases.

20. The antenna apparatus as claimed in claim 18, comprising a first radiator and a second radiator,
wherein loops of radiation conductors of the first and second radiators are configured to be substantially symmetric with respect to a reference axis, and
wherein when proceeding along the symmetric loops of the radiation conductors of the first and second radiators in corresponding directions starting from respective feed points, the first radiator is configured such that the feed point, the inductor, and the capacitor are located in this order, and the second radiator is configured such that the feed point, the capacitor, and the inductor are located in this order.

21. A wireless communication apparatus comprising an antenna apparatus comprising at least one radiator,
wherein each of the radiators comprises:
a looped radiation conductor;
at least one capacitor inserted at a position along a loop of the radiation conductor;
at least one inductor inserted at a position along the loop of the radiation conductor, the position being different from the position of the capacitor; and
a feed point provided on the radiation conductor,
wherein the radiation conductor includes at least a first radiation conductor and a second radiation conductor,
wherein a first capacitor of the at least one capacitor is formed by a capacitance between the first and second radiation conductors, and the capacitance between the first and second radiation conductors varies depending on positions on the first and second radiation conductors within a portion where the first and second radiation conductors are close to each other, and
wherein each of the radiators is configured to:
resonate along a portion of the radiator at a first frequency, the portion including the inductor and the capacitor and being along the loop of the radiation conductor; and
resonate along a portion of the radiator at a second frequency higher than the first frequency, the portion including a section along the loop of the radiation conductor, the section including at least one of the at least one capacitor, not including the inductor, and extending between the feed point and the inductor.
